(19) United States
(12) Patent Application Publication
(10) Pub. No.: US 2013/0081018 A1
(43) Pub. Date: Mar. 28, 2013

(54) Acquiring, presenting and transmitting tasks and subtasks to interface devices

(71) Applicants: Royce A. Levien, Lexington, MA (US); Richard T. Lord, Tacoma, WA (US); Robert W. Lord, Seattle, WA (US); Mark A. Malamud, Seattle, WA (US); John D. Rinaldo, JR., Bellevue, WA (US)

(72) Inventors: Royce A. Levien, Lexington, MA (US); Richard T. Lord, Tacoma, WA (US); Robert W. Lord, Seattle, WA (US); Mark A. Malamud, Seattle, WA (US); John D. Rinaldo, JR., Bellevue, WA (US)

(73) Assignee: Elwha LLC, a limited liability company of the State of Deleware

(21) Appl. No.: 13/317,833

(22) Filed: Oct. 28, 2011

Related U.S. Application Data
(63) Continuation-in-part of application No. 13/200,553, filed on Sep. 23, 2011.
Application No. 13/200,553 is a continuation-in-part of application No. 13/200,797, filed on Sep. 30, 2011.
Application No. 13/200,797 is a continuation-in-part of application No. 13/317,591, filed on Oct. 21, 2011.

(51) Int. Cl. G06F 9/46

(52) U.S. Cl. 718/100

(57) ABSTRACT

A system includes an ignorant interface device subtask acquiring module configured to acquire one or more subtasks that are configured to be carried out by two or more discrete interface devices and which correspond to portions of one or more tasks, wherein at least one of the one or more tasks and an requestor of the one or more tasks are undisclosed to the two or more discrete interface devices, a corresponding subtask representation presentation module configured to present representations corresponding to the one or more subtasks, and a selected subtask data transmission module configured to transmit a subtask of the one or more subtasks corresponding to a selected representation.

### CROSS-REFERENCE TO RELATED APPLICATIONS

The present application is related to and claims the benefit of the earliest available effective filing date(s) from the following listed application(s) (the “Related Applications”) (e.g., claims earliest available priority dates for other than provisional patent applications or claims benefits under 35 USC §119(e) for provisional patent applications, for any and all parent, grandparent, great-grandparent, etc. applications of the Related Application(s)). All subject matter of the Related Applications and of any and all parent, grandparent, great-grandparent, etc. applications of the Related Applications is incorporated herein by reference to the extent such subject matter is not inconsistent herewith.

For purposes of the USPTO extra-statutory requirements, the present application constitutes a continuation-in-part of U.S. patent application Ser. No. 13/200,553, entitled ACQUIRING AND TRANSMITTING TASKS AND SUBTASKS TO INTERFACE DEVICES, naming Royce A. Levien; Richard T. Lord; Robert W. Lord; Mark A. Malamud; and John D. Rinaldo, Jr., as inventors, filed Sep. 23, 2011, which is currently co-pending, or is an application of which a currently co-pending application is entitled to the benefit of the filing date.

For purposes of the USPTO extra-statutory requirements, the present application constitutes a continuation-in-part of U.S. patent application Ser. No. 13/200,797, entitled ACQUIRING AND TRANSMITTING TASKS AND SUBTASKS TO INTERFACE DEVICES, naming Royce A. Levien; Richard T. Lord; Robert W. Lord; Mark A. Malamud; and John D. Rinaldo, Jr., as inventors, filed Sep. 30, 2011, which is currently co-pending, or is an application of which a currently co-pending application is entitled to the benefit of the filing date.

For purposes of the USPTO extra-statutory requirements, the present application constitutes a continuation-in-part of U.S. patent application Ser. No. To Be Assigned, entitled ACQUIRING, PRESENTING AND TRANSMITTING TASKS AND SUBTASKS TO INTERFACE DEVICES, naming Royce A. Levien; Richard T. Lord; Robert W. Lord; Mark A. Malamud; and John D. Rinaldo, Jr., as inventors, filed Oct. 21, 2011, which is currently co-pending, or is an application of which a currently co-pending application is entitled to the benefit of the filing date.

### BACKGROUND

This application is related to using interface devices to collect data.

### SUMMARY

A computationally implemented method includes, but is not limited to acquiring one or more subtasks configured to be carried out by two or more discrete interface devices, the subtasks corresponding to portions of one or more tasks, wherein the one or more tasks and/or a requestor of the one or more tasks are undisclosed to the two or more discrete interface devices, presenting one or more representations corresponding to the one or more subtasks, wherein the one or more representations correspond to the one or more subtasks, and transmitting subtask data corresponding to one or more subtasks in response to selection of one of the one or more corresponding representations. In addition to the foregoing, other method aspects are described in the claims, drawings, and text forming a part of the present disclosure.

In one or more various aspects, related systems include but are not limited to circuitry and/or programming for effecting the herein referenced method aspects; the circuitry and/or programming can be virtually any combination of hardware, software, and/or firmware in one or more machines or article of manufacture configured to effect the herein—referenced method aspects depending upon the design choices of the system designer.

A computationally implemented system includes, but is not limited to: means for acquiring one or more subtasks configured to be carried out by two or more discrete interface devices, the subtasks corresponding to portions of one or more tasks, wherein the one or more tasks and/or a requestor of the one or more tasks are undisclosed to the two or more discrete interface devices, means for presenting one or more representations corresponding to the one or more subtasks, wherein the one or more representations correspond to the one or more subtasks, and means for transmitting subtask data corresponding to one or more subtasks in response to selection of one of the one or more corresponding representations.

A computationally implemented system includes, but is not limited to: circuitry for acquiring one or more subtasks configured to be carried out by two or more discrete interface devices, the subtasks corresponding to portions of one or more tasks, wherein the one or more tasks and/or a requestor of the one or more tasks are undisclosed to the two or more discrete interface devices, circuitry for presenting one or more representations corresponding to the one or more subtasks, wherein the one or more representations correspond to the one or more subtasks, and circuitry for transmitting subtask data corresponding to one or more subtasks in response to selection of one of the one or more corresponding representations.

A computer program product comprising an article of manufacture bearing one or more instructions for acquiring one or more subtasks configured to be carried out by two or more discrete interface devices, the subtasks corresponding to portions of one or more tasks, wherein the one or more tasks and/or a requestor of the one or more tasks are undisclosed to the two or more discrete interface devices, one or more instructions for presenting one or more representations corresponding to the one or more subtasks, wherein the one or more representations correspond to the one or more subtasks, and one or more instructions for transmitting subtask data corresponding to one or more subtasks in response to selection of one of the one or more corresponding representations.

The foregoing summary is illustrative only and is not intended to be in any way limiting. In addition to the illustrative aspects, embodiments, and features described above, further aspects, embodiments, and features will become apparent by reference to the drawings and the following detailed description.

### BRIEF DESCRIPTION OF THE FIGURES

FIG. 1, including FIGS. 1A and 1B, shows a high-level block diagram of an interface device operating in an exemplary environment 100, according to an embodiment.

FIG. 2A shows a particular perspective of the request data receiving module 151 of the computing device 30 of environment 100 of FIG. 1.

FIG. 2B, including FIGS. 2B1 through 2B6, shows a particular perspective of the subtask acquiring module 152 of the computing device 30 of environment 100 of FIG. 1.

FIG. 3A, including FIGS. 3A1 and 3A2, shows a particular perspective of the representation presenting module 154 of the computing device 30 of environment 100 of FIG. 1.

FIG. 4 is a high-level logic flowchart of a process, e.g., operational flow 400, according to an embodiment.

FIG. 5A is a high-level logic flowchart of a process depicting alternate implementations of an acquiring one or more subtasks operation 402 of FIG. 4.

FIG. 5B is a high-level logic flowchart of a process depicting alternate implementations of an acquiring one or more subtasks operation 402 of FIG. 4.

FIG. 5C is a high-level logic flowchart of a process depicting alternate implementations of an acquiring one or more subtasks operation 402 of FIG. 4.

FIG. 6A is a high-level logic flowchart of a process depicting alternate implementations of a presenting one or more representations corresponding to the one or more subtasks operation 404 of FIG. 4.

FIG. 6B is a high-level logic flowchart of a process depicting alternate implementations of a presenting one or more representations corresponding to the one or more subtasks operation 404 of FIG. 4.

FIG. 6C is a high-level logic flowchart of a process depicting alternate implementations of a presenting one or more representations corresponding to the one or more subtasks operation 404 of FIG. 4.

FIG. 6D is a high-level logic flowchart of a process depicting alternate implementations of a presenting one or more representations corresponding to the one or more subtasks operation 404 of FIG. 4.

FIG. 6E is a high-level logic flowchart of a process depicting alternate implementations of a presenting one or more representations corresponding to the one or more subtasks operation 404 of FIG. 4.

FIG. 6F is a high-level logic flowchart of a process depicting alternate implementations of a presenting one or more representations corresponding to the one or more subtasks operation 404 of FIG. 4.

FIG. 6G is a high-level logic flowchart of a process depicting alternate implementations of a presenting one or more representations corresponding to the one or more subtasks operation 404 of FIG. 4.

FIG. 6H is a high-level logic flowchart of a process depicting alternate implementations of a presenting one or more representations corresponding to the one or more subtasks operation 404 of FIG. 4.

FIG. 6I is a high-level logic flowchart of a process depicting alternate implementations of a presenting one or more representations corresponding to the one or more subtasks operation 404 of FIG. 4.

FIG. 6J is a high-level logic flowchart of a process depicting alternate implementations of a presenting one or more representations corresponding to the one or more subtasks operation 404 of FIG. 4.

FIG. 6K is a high-level logic flowchart of a process depicting alternate implementations of a presenting one or more representations corresponding to the one or more subtasks operation 404 of FIG. 4.

FIG. 6L is a high-level logic flowchart of a process depicting alternate implementations of a presenting one or more representations corresponding to the one or more subtasks operation 404 of FIG. 4.

FIG. 6M is a high-level logic flowchart of a process depicting alternate implementations of a presenting one or more representations corresponding to the one or more subtasks operation 404 of FIG. 4.

FIG. 6N is a high-level logic flowchart of a process depicting alternate implementations of a presenting one or more representations corresponding to the one or more subtasks operation 404 of FIG. 4.

FIG. 6P is a high-level logic flowchart of a process depicting alternate implementations of a presenting one or more representations corresponding to the one or more subtasks operation 404 of FIG. 4.

FIG. 7A is a high-level logic flowchart of a process depicting alternate implementations of a transmitting subtask data operation 406 of FIG. 4.

FIG. 7B is a high-level logic flowchart of a process depicting alternate implementations of a transmitting subtask data operation 406 of FIG. 4.

FIG. 7C is a high-level logic flowchart of a process depicting alternate implementations of a transmitting subtask data operation 406 of FIG. 4.

### DETAILED DESCRIPTION

In the following detailed description, reference is made to the accompanying drawings, which form a part hereof. In the drawings, similar symbols typically identify similar or identical components or items, unless context dictates otherwise. The illustrative embodiments described in the detailed description, drawings, and claims are not meant to be limiting. Other embodiments may be utilized, and other changes may be made, without departing from the spirit or scope of the subject matter presented here.

The emergence of portable computing devices (e.g., laptop computers, computer tablets, digital music players, personal navigation systems, net books, smart phones, personal digital assistants (“PDAs”), digital still cameras, digital video cameras, and handheld game devices, e.g., PlayStation Portable and Nintendo 3DS) into all segments of society over the last two decades has resulted in vast socioeconomic benefits generally enriching the lives of those who choose to take advantage of the benefits that such devices provide. The rise in the portability of such devices has provided a wealth of information available to a user.

In addition, the promulgation of portable electronic devices, each having their own set of unique sensors and detectors, has been widespread. Currently, there are very few populated areas of developed countries which do not contain a large number of portable computing devices at any given time. These portable computing devices are constantly collecting data, and capable of collecting data, which is not stored in any repository or transmitted to any device which may use such data. Thus, such data, and opportunity to collect data, may be lost.

In accordance with various embodiments, computationally implemented methods, systems, and articles of manufacture are provided that can determine whether a computing device used by a first user has been transferred from the first user to a second user; and in response to determining that the computing device has been transferred from the first user to the second user, automatically reconfigure the computing device to restrict access to one or more items (e.g., documents, files, image or audio files, applications, passwords, and so forth) that may have been accessible to the first user when the first user was using the computing device. In various embodiments, such computationally implemented methods, systems, and articles of manufacture may be implemented at the computing device.

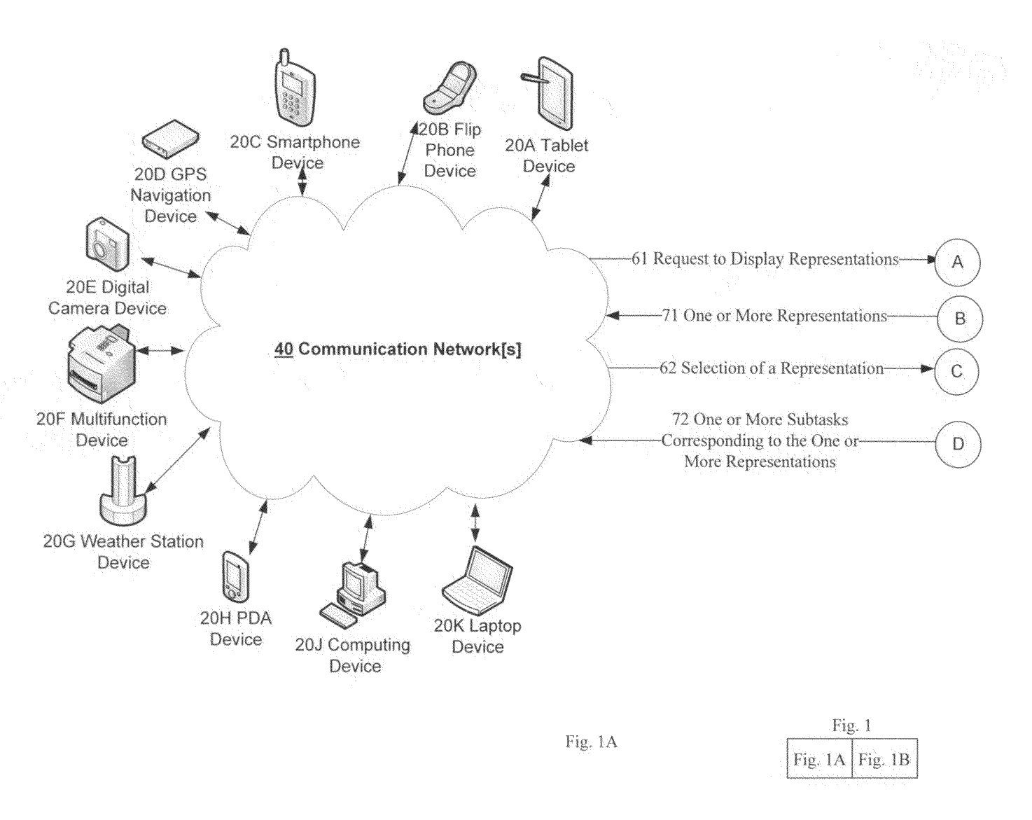

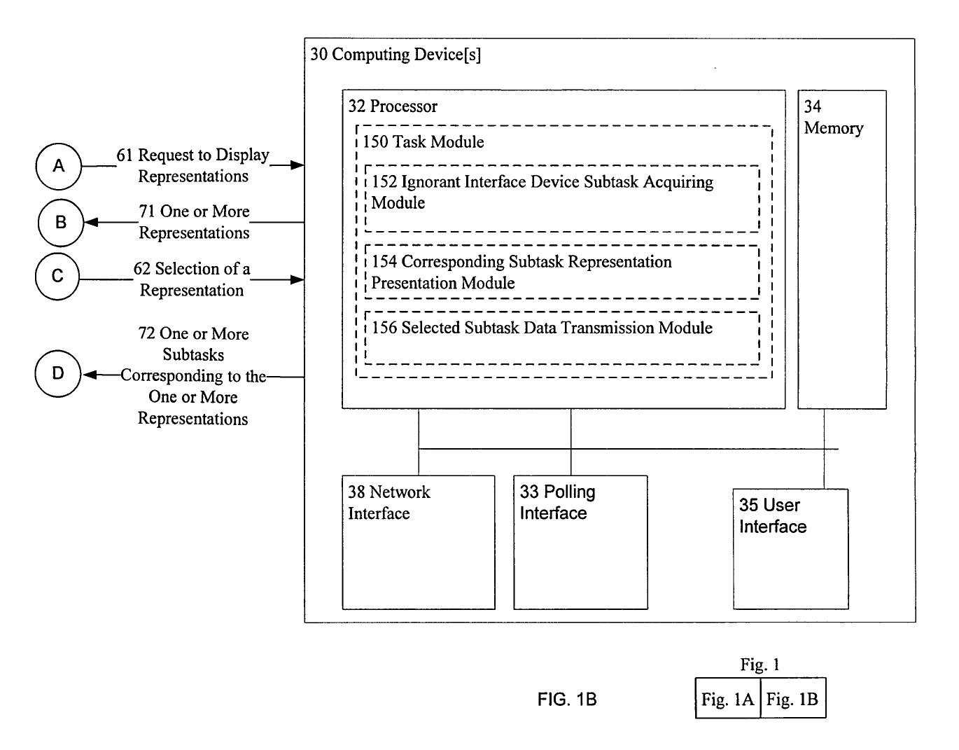

Referring now to FIG. 1, FIG. 1 illustrates a computing device 30 in an exemplary environment 100. As will be described in more detail herein, the illustrated computing device 30 may employ the computationally implemented methods, systems, and articles of manufacture in accordance with various embodiments. The computing device 30, in various embodiments, may be endowed with logic that is designed to acquire one or more subtasks that correspond to portions of one or more tasks configured to be carried out by two or more discrete interface devices, present one or more representations, and transmit subtask data corresponding to one or more subtasks in response to selection of one of the one or more corresponding representations.

In some embodiments, the computing device 30 may be a network device such as a server. Alternatively, the computing device 30 may be a plurality of network devices such as a plurality of network computers, servers, and storage devices. The one or more computing devices are connected via a communications network 40.

Note that in the following description, the character “*” represents a wildcard. Thus, references to, for example, interface devices 20* of FIG. 1 may be in reference to tablet device 20a, flip phone device 20b, smartphone device 20c, GPS navigation device 20D, digital camera device 20E, multifunction device 20F, weather station device 20G, PDA device 20H, computing device 20J, and laptop device 20K. Within the context of this application, “discrete interface device” is defined as an “interface device capable of operating or being operated independently of other discrete interface devices.” The discrete interface devices may be completely unaware of each other, and are not necessarily the same type. For example, FIG. 1 illustrates discrete interface device 20A as a tablet, discrete interface device 20B as a flip phone, and discrete interface device 20C as a smartphone device. These drawings are meant to be illustrative only, and should not be construed as limiting the definition of discrete interface devices 20*, which can be any device with computing functionality. For example, discrete interface devices 20* include but are not limited to laptop computers, computer tablets, digital music players, personal navigation systems, net books, smart phones, PDAs, digital still cameras, digital video cameras, vehicle assistance systems, and handheld game devices. For the purposes of this application, the type of interface device is not important, except that it can communicate with a communications network, and that it has device characteristics and status, as will be described in more detail herein.

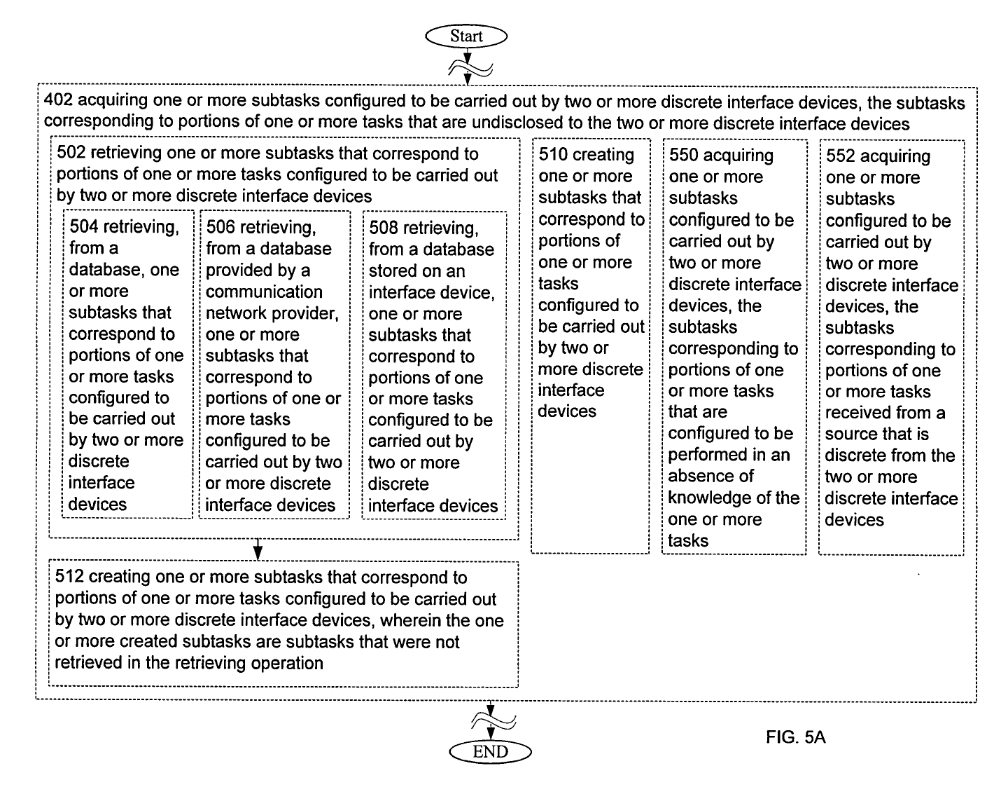

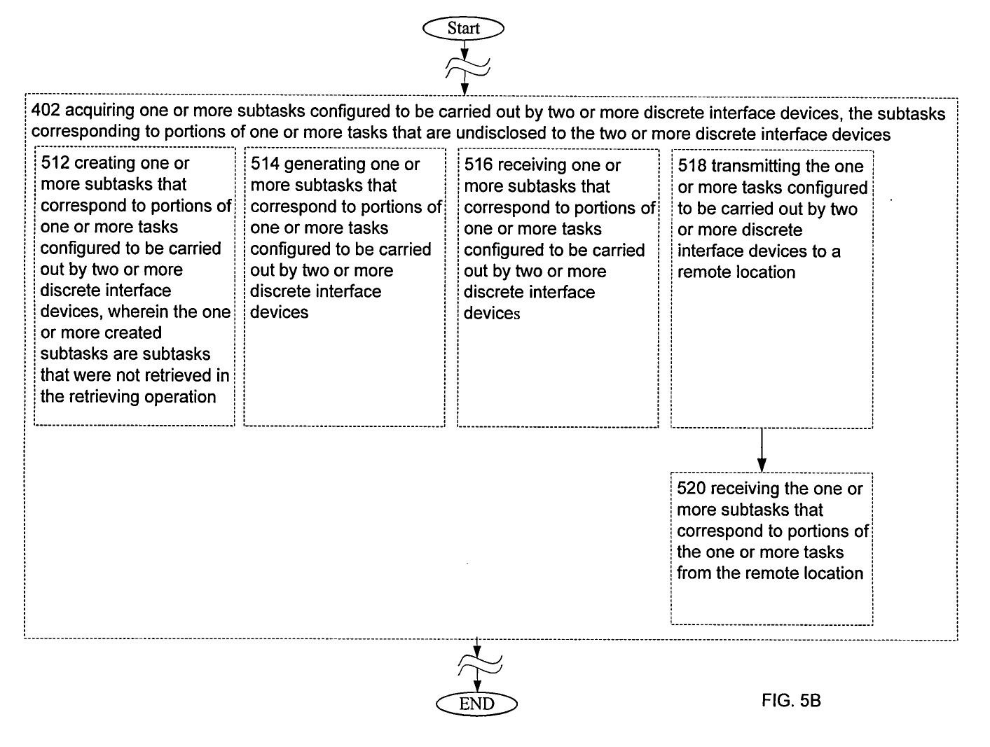

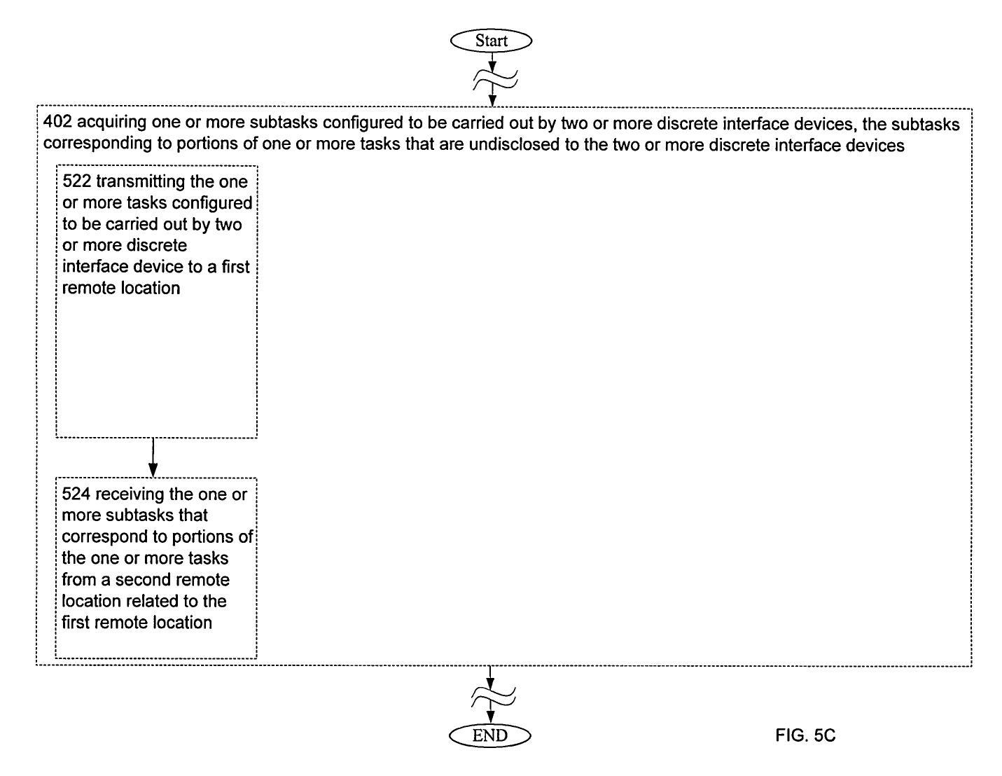

Referring again to the example environment 100 of FIG. 1, in various embodiments, the computing device 30 may comprise, among other elements, a processor 32, a memory 34, a network interface 38, a polling interface 33, and a user interface 35. Computing device 30 also may include a processor 32. Processor 32 may include one or more microprocessors, Central Processing Units (“CPU”), a Graphics Processing Units (“GPU”), Physics Processing Units, Digital Signal Processors, Network Processors, Floating Point Processors, and the like. In some embodiments, processor 32 may be a server. In some embodiments, processor 32 may be a distributed-core processor. Although processor 32 is depicted as a single processor that is part of a single computing device 30, in some embodiments, processor 32 may be multiple processors distributed over one or many computing devices 30, which may or may not be configured to work together. Processor 32 is illustrated as being configured to execute computer readable instructions in order to execute one or more operations described above, and as illustrated in FIGS. 5, 6A-6C, 7A-7D, 8A-8C, and 9. In some embodiments, processor 32 is designed to be configured to operate as the task application module 150, which may include request data receiving module 151, subtask acquiring module 152, interface selecting module 153, subtask transmitting module 154, and result data receiving module 155.

As described above, the computing device 30 may comprise a memory 34. In some embodiments, memory 34 may comprise of one or more of one or more mass storage devices, read-only memory (ROM), programmable read-only memory (PROM), erasable programmable read-only memory (EPROM), cache memory such as random access memory (RAM), flash memory, synchronous random access memory (SRAM), dynamic random access memory (DRAM), and/or other types of memory devices. In some embodiments, memory 34 may be located at a single network site. In other embodiments, memory 34 may be located at multiple network sites, including sites that are distant from each other.

The computing device 30 may communicate via a communications network 40. In various embodiments, the communication network 40 may include one or more of a local area network (LAN), a wide area network (WAN), a metropolitan area network (MAN), a wireless local area network (WLAN), a personal area network (PAN), a Worldwide Interoperability for Microwave Access (WiMAX), public switched telephone network (PTSN), a general packet radio service (GPRS) network, a cellular network, and so forth. The communication networks 40 may be wired, wireless, or a combination of wired and wireless networks. It is noted that “communication network” here refers to communication networks, which may or may not interact with each other.

Communications between the computing device 30 and the communications network 40 may be facilitated by the network interface module 38, which may be implemented as hardware or software, or both, used to interface the computing device 30 with the one or more communication networks 40. In some embodiments, the network interface module 38 may be a Network Interface Card, e.g., a NIC. The specific structure of network interface module 38 depends on the type or types of one or more communication networks 40 that are used. Particular details of this transmission will be discussed in more detail herein.

As described above, and with reference to FIG. 1, computing device 30 may include a polling interface 33. Polling interface 33 may be implemented in hardware, or software, or both, and may communicate with the communication network 40 in order to poll devices, e.g., interface devices. Polling interface 33 may be similar to network interface 38, with the additional functionality of polling interface devices 20*, as well as listening for interface devices 20* that may be attempting to communicate with computing device 30.

As described above, and with reference to FIG. 1, computing device 30 may include a user interface 35. The user interface may be implemented in hardware or software, or both, and may include various input and output devices to allow an operator of a computing device 30 to interact with computing device 30. For example, user interface 35 may include, but is not limited to, an audio display, a video display, a microphone, a camera, a keyboard, a mouse, a joystick, a game controller, a touchpad, a handset, or any other device that allows interaction between a computing device and a user.

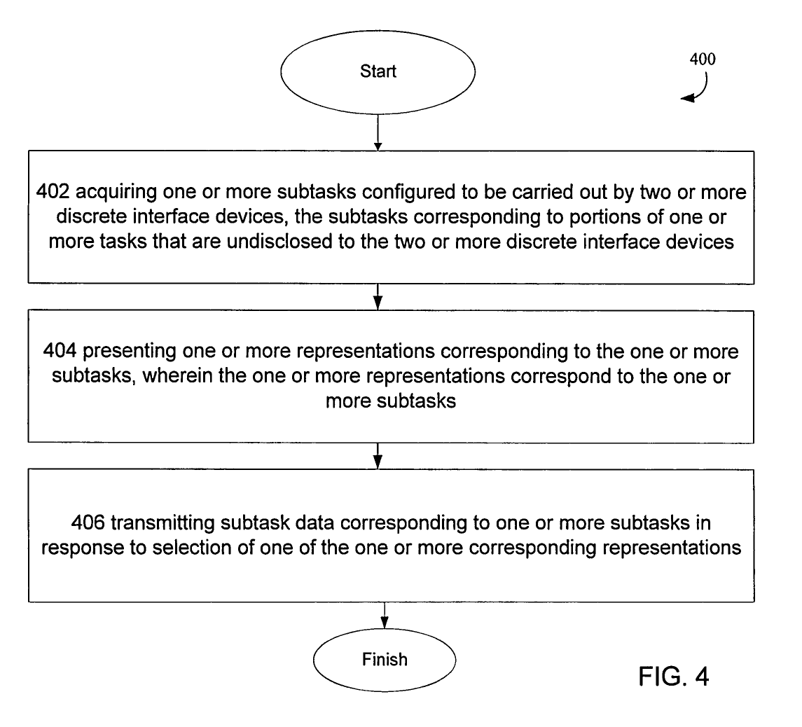

In some cases, a “user” is a representation of a person operating an electronic device, e.g., a portable computing device, or a non-portable computing device, e.g., a desktop computer, an information kiosk, or a terminal, e.g., an ATM terminal. In another embodiment, however, a user is merely a representation of someone making a request. For example, a user may be an automated program that sends a request to carry out a task of acquiring data. For example, and in some embodiments, an automated weather tracking station may send out a request for the temperature and barometric pressure in a particular geographic area, e.g., a zip code, each day at the same time. As will be further described with reference to FIG. 4, the operational flow 400 may be executed in a variety of different ways in various alternative implementations, which will be discussed in more detail herein.

As shown in environment 100 of FIG. 1, task module 150 may be configured to receive a request to display representations 61, to transmit one or more representations (or commands corresponding to representations, or instructions for presenting representations) 71, to receive a selection of a representation 62, and to transmit one or more subtasks corresponding to the one or more representations 72.

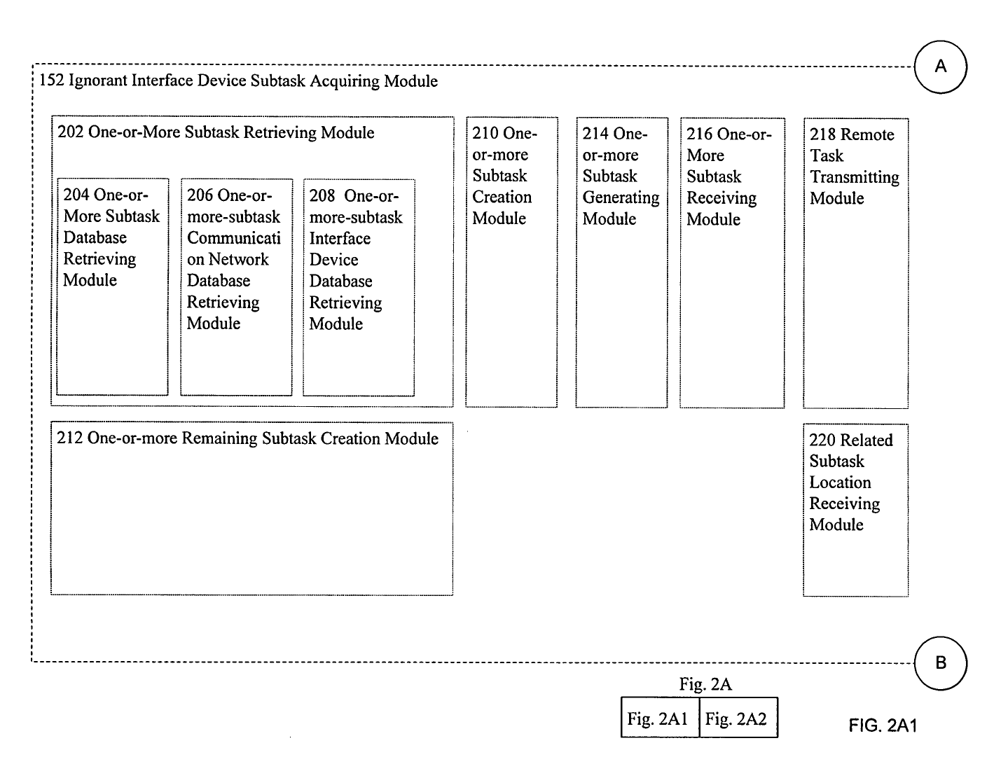

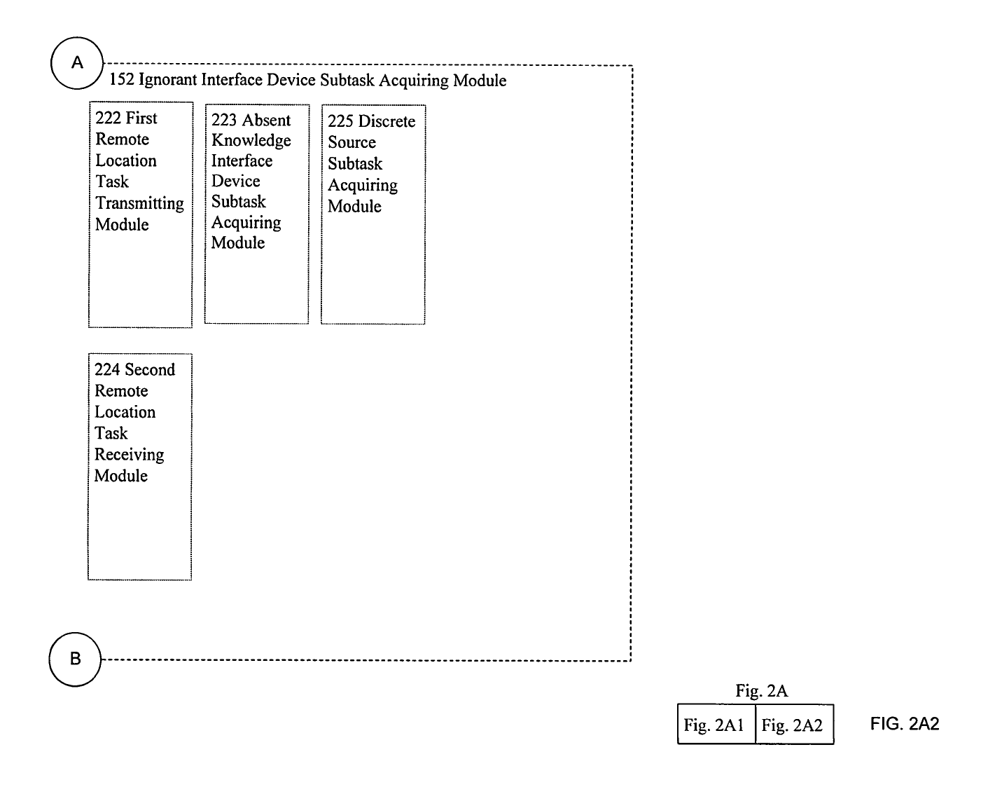

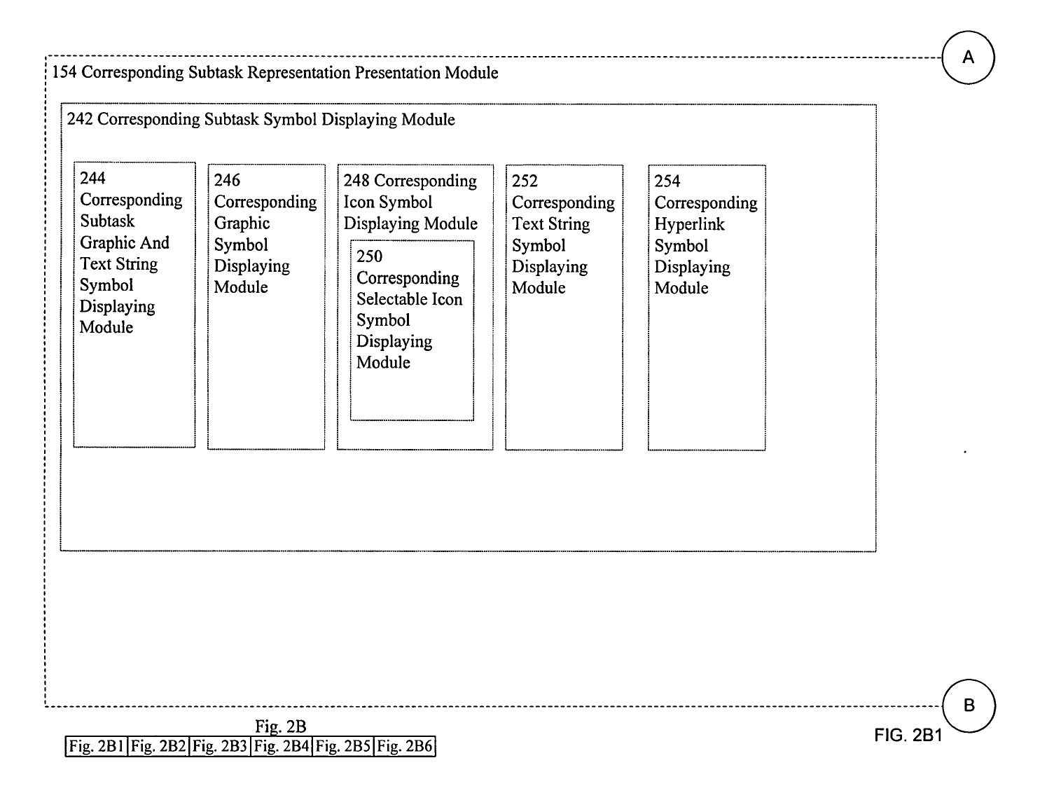

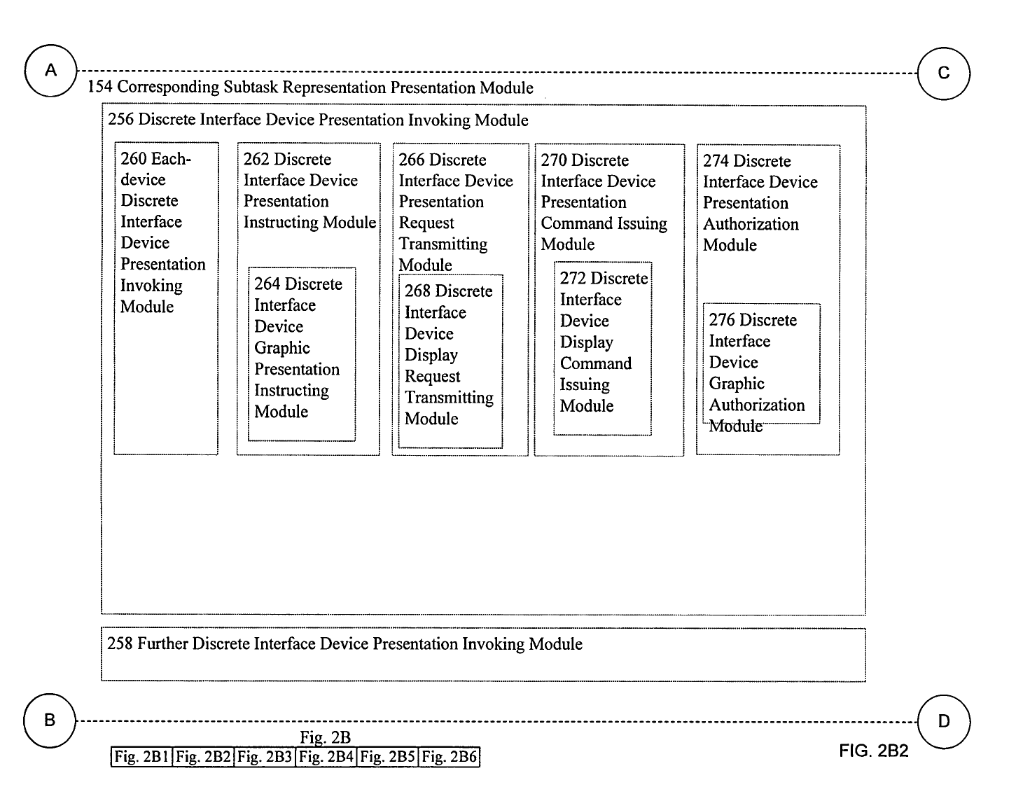

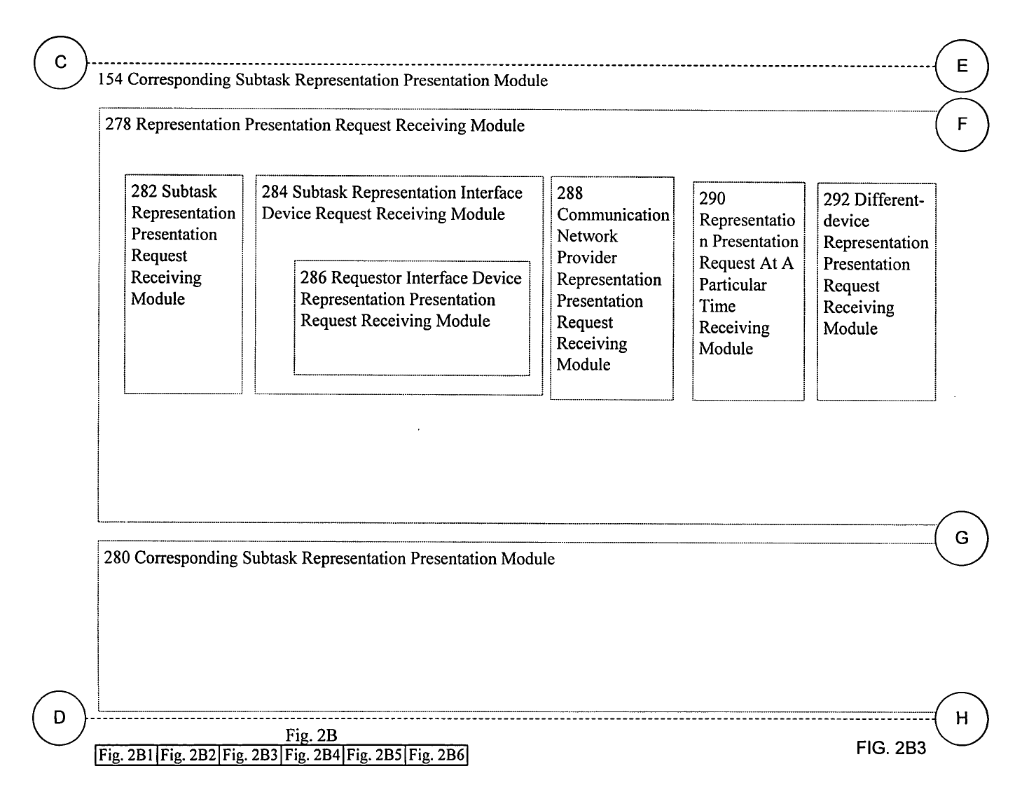

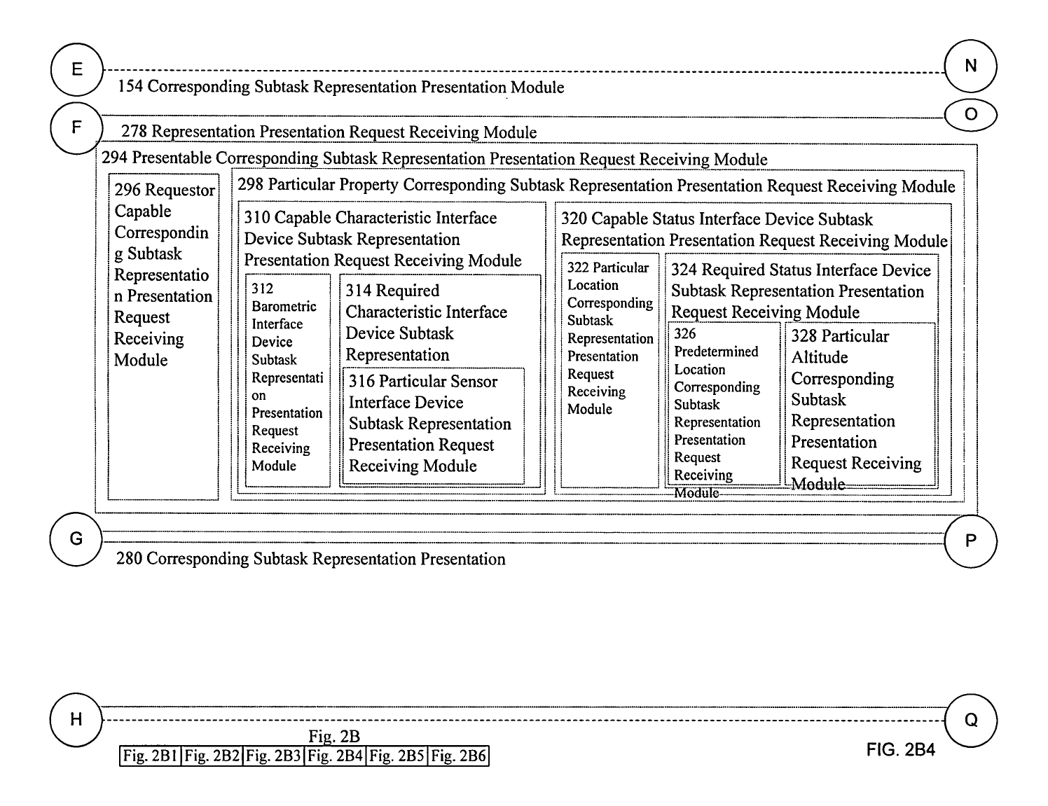

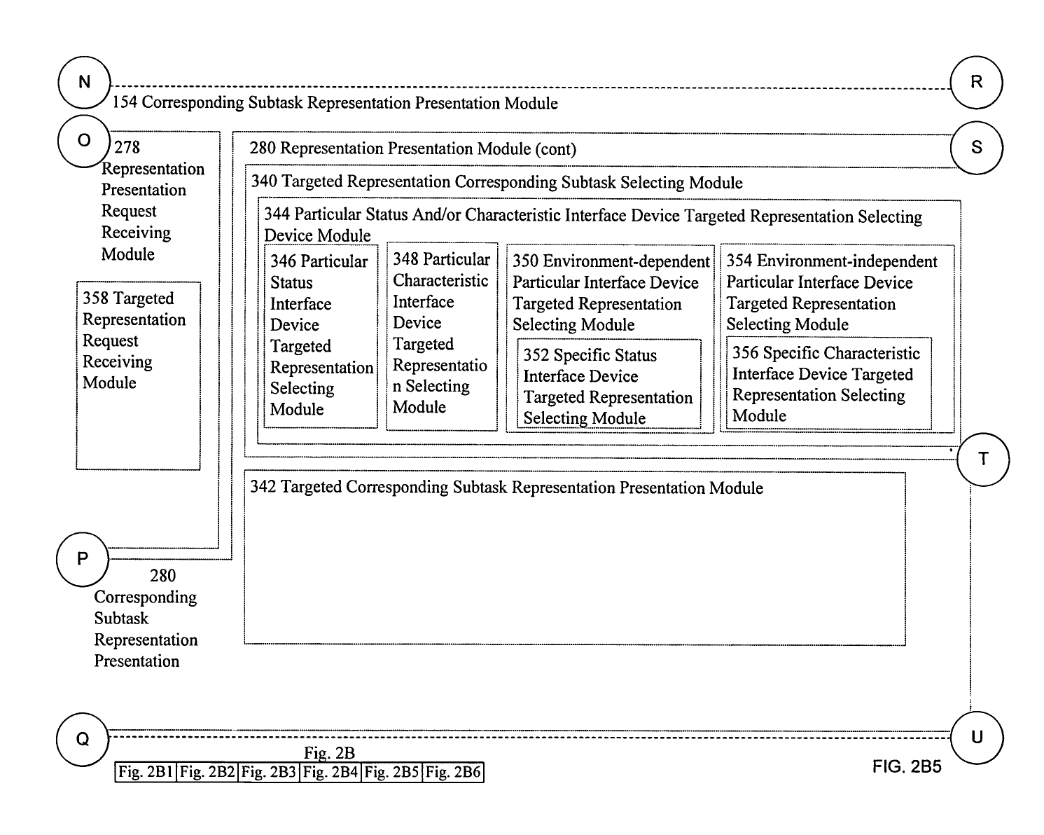

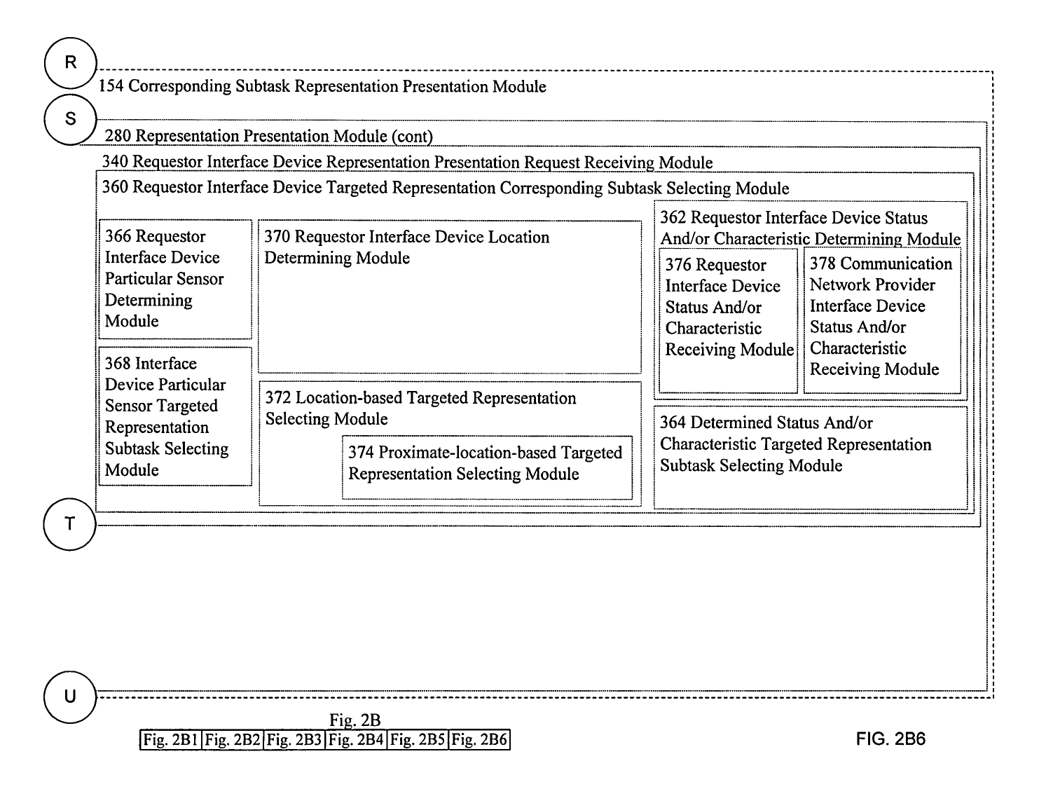

Referring now to FIG. 2A, FIG. 2A illustrates an exemplary implementation of the subtask acquiring module 152 of the task module 150. As illustrated in FIG. 2A, the subtask acquiring module 152 may include one or more sub-logic modules in various alternative implementations. For example, in some embodiments, the subtask acquiring module 152 may include a subtask retrieving module 202 (e.g., which, in some embodiments, may further include a subtask database retrieving module 204, a subtask network provider database retrieving module 206, and a subtask interface device database retrieving module 208), a subtask creating module 210, a partial subtask creating module 212, a subtask generating module 214, a subtask receiving module 216, a task transmitting module 218, a subtask remote location receiving module 220, a first remote location task transmitting module 222, and a second remote location task receiving module 224. Specific details related to the subtask acquiring module 152, as well as the above-described sub-modules of the subtask acquiring module 152 will be provided below with respect to the operations and processes to be described herein.

Referring now to FIG. 2B, FIG. 2B illustrates an exemplary implementation of representation presenting module 154. As illustrated in FIG. 2B, representation presenting module 154 may include one or more sub-logic modules in various alternative implementations. For example, in some embodiments, the representation presenting module 154 may include a symbol presenting module 242. In addition, in some embodiments, symbol presenting module 242 may further include graphic and text string displaying module 244, a graphics displaying module 246, an icon displaying module 248 (e.g., which, in some embodiments, may further include a selectable icon displaying module 250), a text string displaying module 252, and a hyperlink displaying module 254. In some embodiments, the representation presenting module 154 may include a presentation invoking module 256 and an another interface device presentation invoking module 258. Presentation invoking module 256 may further include each interface device presentation invoking module 260, representation presentation instructing module 262 (e.g., which, in some embodiments, may further include graphic display instructing module 264), representation presentation request transmitting module 266 (e.g., which, in some embodiments, may further include graphic display request transmitting module 268), representation presentation command issuing module 270 (e.g., which, in some embodiments, may further include graphic display command issuing module 272), and representation presentation authorizing module 274 (e.g., which, in some embodiments, may further include graphic display authorizing module 276).

In some embodiments, the representation presenting module 154 may include a representation presentation request receiving module 278, and a representation presentation module 280. In some embodiments, representation presentation request receiving module 278 may further include subtask representation presentation request receiving module 282, subtask representation interface device request receiving module 284 (e.g., which, in some embodiments, may further include requestor interface device request receiving module), network provider request receiving module 288, predetermined time request receiving module 290, first interface device request receiving module 292, presentable subtask request receiving module 294, and targeted representation request receiving module 358. In some embodiments, presentable subtask request receiving module 294 may further include requestor interface device request receiving module 296 and particular property subtask receiving module 298. In some embodiments, particular property subtask receiving module 298 may further include particular characteristic subtask request receiving module 310 (e.g., which, in some embodiments, may include barometer subtask request receiving module 312, required characteristic subtask request receiving module 314 (e.g., which, in some embodiments, may include required sensor subtask request receiving module (e.g., which, in some embodiments, may include still camera subtask request receiving module 318))) and particular status subtask request receiving module 320 (e.g., particular location subtask request receiving module 322 and required status subtask request receiving module (e.g., which, in some embodiments, may include proximity subtask request receiving module 326 and altitude subtask request receiving module 328)).

In some embodiments, the representation presentation module 280 may further include targeted representation selecting module 340 and selected targeted representation presenting module. In some embodiments, targeted representation selecting module 340 may further include status and/or characteristic selecting module 344 and requestor interface device subtask selecting module 360. In some embodiments, status and/or characteristic selecting module 344 may further include status selecting module 346, characteristic selection module 348, environment-dependent selecting module 350 (e.g., which, in some embodiments, may include exemplary status selecting module 352) and environment-independent selecting module 354 (e.g., which, in some embodiments, may include exemplary characteristic selecting module). In some embodiments, requestor interface device subtask selecting module 360 may include requestor interface device sensor determining module 366, determined sensor subtask selecting module 368, requestor interface device location determining module 370, determined location subtask selecting module 372 (e.g., which, in some embodiments, may include determined range of location subtask selecting module 374), requestor interface device determining module 362 (e.g., which may include interface device information receiving module 376 and communication network information receiving module 378), and determined requestor interface device subtask selecting module 364.

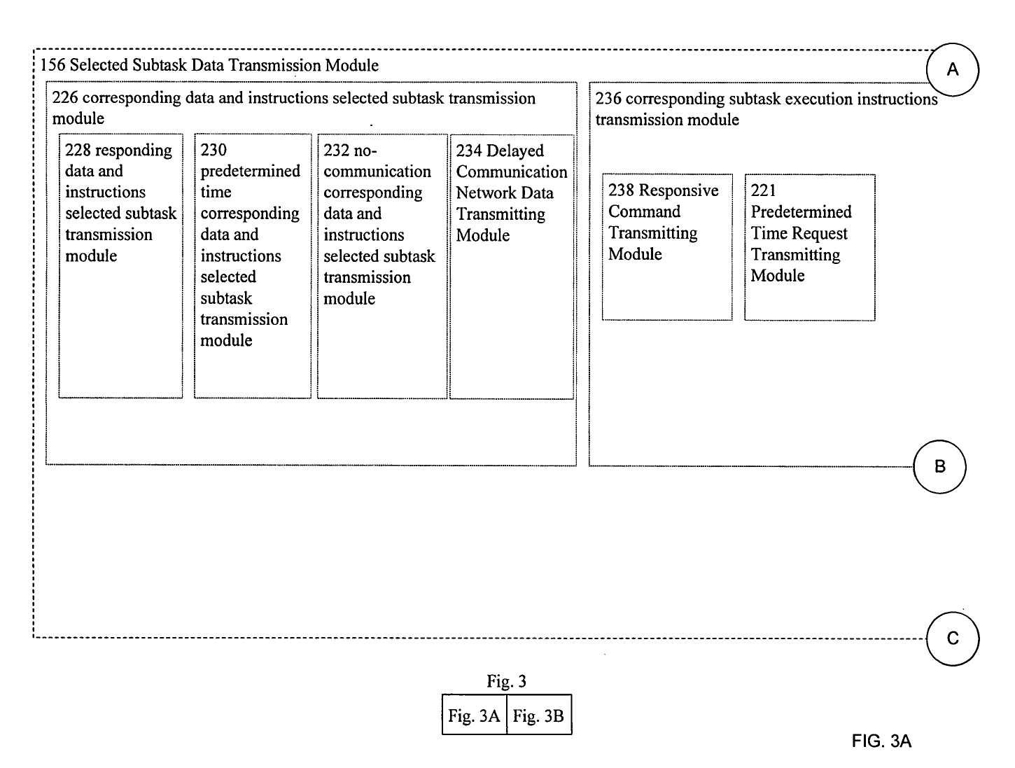

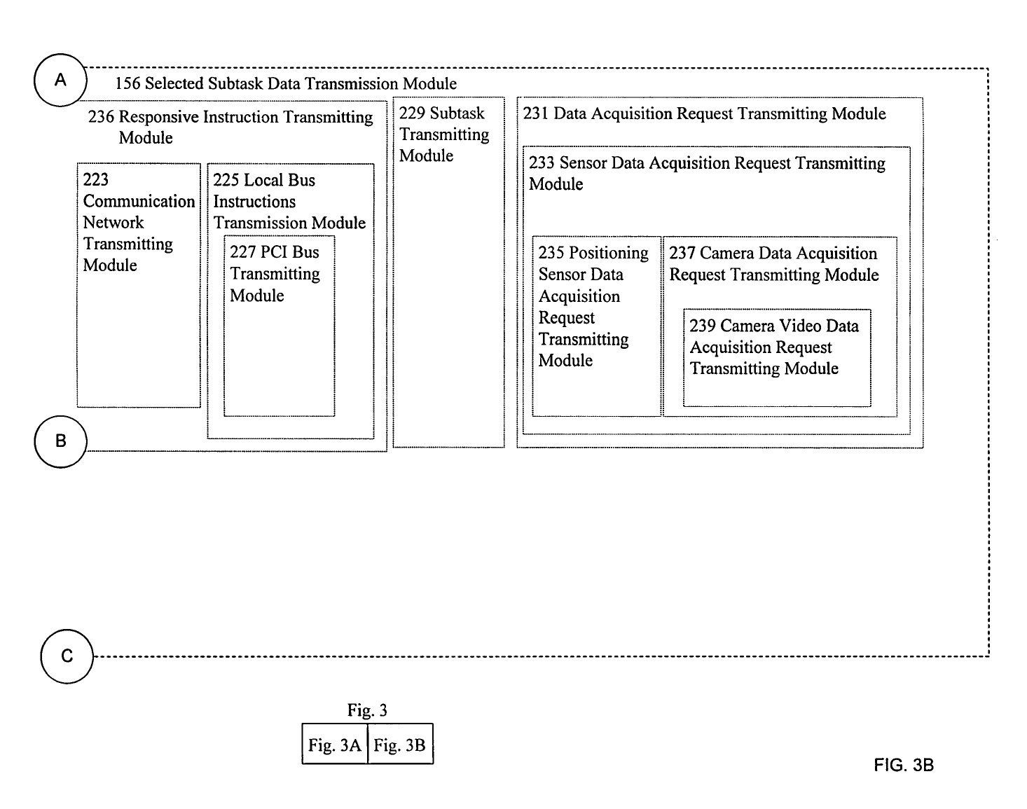

With reference now to FIG. 3, FIG. 3 illustrates an exemplary implementation of data transmitting module 156. As illustrated in FIG. 3, data transmitting module 156 may include one or more sub-logic modules in various alternative implementations. For example, in some embodiments, the data transmitting module 156 may include representation and instruction transmitting module 226, responsive instruction transmitting module 236, subtask transmitting module 229, and data acquisition request transmitting module 231. In some embodiments, representation and instruction transmitting module 226 may further include received request representation and instruction transmitting module 228, predetermined time representation and instruction transmitting module 230, delayed data transmitting module 232, and delayed communication network data transmitting module 234. Responsive instruction transmitting module 236 may further include responsive command transmitting module 238, predetermined time request transmitting module 221, communication network transmitting module 223, and local bus transmitting module 225 (e.g., which, in some embodiments, may include PCI bus transmitting module 227). In some embodiments, data acquisition request transmitting module 231 may include subtask data acquisition request transmitting module 233. In some embodiments, subtask data acquisition request transmitting module 233 may include positioning sensor data acquisition request transmitting module 235 and camera data acquisition request transmitting module 237 (e.g., which, in some embodiments, may include camera video data acquisition request transmitting module).

A more detailed discussion related to computing device 30 of FIG. 1 will now be provided with respect to the processes and operations to be described herein. FIG. 4 illustrates an operational flow 400 representing example operations for, among other methods, acquiring one or more subtasks that correspond to portions of one or more tasks configured to be carried out by two or more discrete interface devices, presenting one or more representations, and transmitting subtasks corresponding to selected representations. In FIG. 4 and in the following figures that include various examples of operational flows, discussions and explanations will be provided with respect to the exemplary environment 100 as described above and as illustrated in FIG. 1, and with respect to other examples (e.g., as provided in FIGS. 2A, 2B, and 3) and contexts. It should be understood that the operational flows may be executed in a number of other environments and contexts, and/or in modified versions of the systems shown in FIGS. 2A, 2B, and 3. Although the various operational flows are presented in the sequence(s) illustrated, it should be understood that the various operations may be performed in other orders other than those which are illustrated, or may be performed concurrently.

In some implementations described herein, logic and similar implementations may include software or other control structures. Electronic circuitry, for example, may have one or more paths of electrical current constructed and arranged to implement various functions as described herein. In some implementations, one or more media may be configured to bear a device-detectable implementation when such media hold or transmit device detectable instructions operable to perform as described herein. In some variants, for example, implementations may include an update or modification of existing software or firmware, or of gate arrays or programmable hardware, such as by performing a reception of or a transmission of one or more instructions in relation to one or more operations described herein. Alternatively or additionally, in some variants, an implementation may include special-purpose hardware, software, firmware components, and/or general-purpose components executing or otherwise invoking special-purpose components. Specifications or other implementations may be transmitted by one or more instances of tangible transmission media as described herein, optionally by packet transmission or otherwise by passing through distributed media at various times.

Following are a series of flowcharts depicting implementations. For ease of understanding, the flowcharts are organized such that the initial flowcharts present implementations via an example implementation and thereafter the following flowcharts present alternate implementations and/or expansions of the initial flowchart(s) as either sub-component operations or additional component operations building on one or more earlier-presented flowcharts. Those having skill in the art will appreciate that the style of presentation utilized herein (e.g., beginning with a presentation of a flowchart(s) presenting an example implementation and thereafter providing additions to and/or further details in subsequent flowcharts) generally allows for a rapid and easy understanding of the various process implementations. In addition, those skilled in the art will further appreciate that the style of presentation used herein also lends itself well to modular and/or object-oriented program design paradigms.

Further, in FIG. 4 and in the figures to follow thereafter, various operations may be depicted in a box-within-a-box manner. Such depictions may indicate that an operation in an internal box may comprise an optional example embodiment of the operational step illustrated in one or more external boxes. However, it should be understood that internal box operations may be viewed as independent operations separate from any associated external boxes and may be performed in any sequence with respect to all other illustrated operations, or may be performed concurrently. Still further, these operations illustrated in FIG. 4 as well as the other operations to be described herein may be performed by at least one of a machine, an article of manufacture, or a composition of matter.

It is noted that, for the examples set forth in this application, the tasks and subtasks are commonly represented by short strings of text. This representation is merely for ease of explanation and illustration, and should not be considered as defining the format of tasks and subtasks. Rather, in various embodiments, the tasks and subtasks may be stored and represented in any data format or structure, including numbers, strings, Booleans, classes, methods, complex data structures, and the like.

Those having skill in the art will recognize that the state of the art has progressed to the point where there is little distinction left between hardware, software, and/or firmware implementations of aspects of systems; the use of hardware, software, and/or firmware is generally (but not always, in that in certain contexts the choice between hardware and software can become significant) a design choice representing cost vs. efficiency tradeoffs. Those having skill in the art will appreciate that there are various vehicles by which processes and/or systems and/or other technologies described herein can be effected (e.g., hardware, software, and/or firmware), and that the preferred vehicle will vary with the context in which the processes and/or systems and/or other technologies are deployed. For example, if an implementer determines that speed and accuracy are paramount, the implementer may opt for a mainly hardware and/or firmware vehicle; alternatively, if flexibility is paramount, the implementer may opt for a mainly software implementation; or, yet again alternatively, the implementer may opt for some combination of hardware, software, and/or firmware. Hence, there are several possible vehicles by which the processes and/or devices and/or other technologies described herein may be effected, none of which is inherently superior to the other in that any vehicle to be utilized is a choice dependent upon the context in which the vehicle will be deployed and the specific concerns (e.g., speed, flexibility, or predictability) of the implementer, any of which may vary. Those skilled in the art will recognize that optical aspects of implementations will typically employ optically-oriented hardware, software, and or firmware.

With reference now to FIG. 4, FIG. 4 shows operational flow 400. Operational flow 400 depicts operation 402, which depicts acquiring one or more subtasks configured to be carried out by two or more discrete interface devices, the subtasks corresponding to portions of one or more tasks, wherein the one or more tasks and/or a requestor of the one or more tasks are undisclosed to the two or more discrete interface devices. For example, referring to FIG. 1, FIG. 1 shows ignorant interface device subtask acquiring module 152 acquiring one or more subtasks (e.g., “a request to take a picture,”) configured to be carried out by two or more discrete interface devices (e.g., an iPhone with a camera and a BlackBerry 8800 with a camera), the subtasks corresponding to portions of one or more tasks (e.g., “take a 360-degree near-real-time picture of the Eiffel Tower in France) that are undisclosed to the two or more discrete interface devices (e.g., the iPhone and the BlackBerry, as well as their users, do not know the task, do not know what they are taking a picture of, and do not know what the end result of their carrying out the subtask will be.

Referring again to FIG. 4, operational flow 400 depicts operation 404, which shows presenting one or more representations corresponding to the one or more subtasks, wherein the one or more representations correspond to the one or more subtasks. For example, FIG. 1 shows corresponding subtask representation presentation module 154 presenting (e.g., displaying or causing to display) one or more representations (e.g., pictures, icons, or text) corresponding to the one or more subtasks (e.g., “a request to take a picture,”), wherein the one or more representations correspond to the one or more subtasks (e.g., one icon represents “a request to take a picture,” another icon represents “measure the temperature,” and another icon represents “determine the altitude of the interface device”).

Referring again to FIG. 4, operational flow 400 depicts operation 406, which shows transmitting subtask data corresponding to one or more subtasks in response to selection of one of the one or more corresponding representations. For example, FIG. 1 shows selected subtask data transmission module 156 transmitting subtask data corresponding to one or more subtasks (e.g., “a request to take a picture”) in response to selection of one of the one or more corresponding representations (e.g., a pictorial icon displayed on a screen of an interface device and representing “a request to take a picture” was selected by a user operating the interface device).

Referring to FIG. 5A, operation 402 may include operation 550 depicting acquiring one or more subtasks configured to be carried out by two or more discrete interface devices, the subtasks corresponding to portions of one or more tasks that are configured to be performed in an absence of knowledge of the one or more tasks and/or an absence of knowledge of a requestor of the one or more tasks. For example, FIG. 2A shows absent knowledge interface device subtask acquiring module 223 depicting acquiring one or more subtasks (e.g., “lift the interface device out into the air”) configured to be carried out by two or more discrete interface devices (e.g., an iPhone and a Samsung Galaxy S2), the subtasks corresponding to portions of one or more tasks (e.g., “take a picture of the view from this point in the stadium for the Seahawks game,” “measure the cloud cover currently at the stadium for the Seahawks game,” “determine, using barometric pressure, whether a storm is moving southward through Seattle, Wash.”) in an absence of knowledge of the one or more tasks (e.g., the interface device and its user do not know the task they are going to carry out, and may not know the sensor being used to collect information (e.g., the interface device may transmit all the information collected from its sensors)).

Referring again to FIG. 5A, operation 402 may include operation 552 depicting acquiring one or more subtasks configured to be carried out by two or more discrete interface devices, the subtasks corresponding to portions of one or more tasks received from a source that is discrete from the two or more discrete interface devices. For example, FIG. 2A shows discrete source interface device subtask acquiring module 225 acquiring one or more subtasks (e.g., “point the camera of the interface device in the indicated direction and take a picture”) configured to be carried out by two or more discrete interface devices (e.g., a Nokia E7 and an HTC Evo), the subtasks corresponding to portions of one or more tasks (e.g., “take a 360-degree picture of the crowd in section 102 of Safeco Field”) received from a source that is discrete from the two or more discrete interface devices (e.g., received from a BlackBerry 8800 of a user sitting in section 102 of Safeco Field.”) In this example, similarly to as above, the user of the interface device, as well as the interface device, do not know what they are taking a picture of. The interface device is merely pointed in the requested direction, and a picture is taken.

Referring again to FIG. 5A, operation 402 may include operation 502 depicting retrieving one or more subtasks that correspond to portions of one or more tasks configured to be carried out by two or more discrete interface devices. For example, FIG. 2A shows one-or-more subtask retrieving module 202 retrieving one or more subtasks (e.g., obtaining, from a depository, e.g., a database created on the Radiohead website, one or more subtasks (e.g., “determine if it is raining at the corner of 2^{nd} and Main”)) that correspond to portions of one or more tasks (“determine the weather for the Radiohead outdoor show”) configured to be carried out by two or more discrete interface devices (e.g., a Nokia E5 and an iPhone 4G).

Referring again to FIG. 5A, operation 402 may include operation 504 depicting retrieving, from a database, one or more subtasks that correspond to portions of one or more tasks configured to be carried out by two or more discrete interface devices. For example, FIG. 2A shows one-or-more subtask database retrieving module 204 retrieving, from a database (e.g., a database of related subtasks, e.g., weather-related subtasks maintained by the Weather Channel Corporation), one or more subtasks (e.g., “measure the temperature,” “measure the cloud cover,” “measure the barometric pressure changes”) that correspond to portions of one or more tasks (e.g., “develop a nationwide weather map,” “develop a Seattle-area cloud coverage map”) configured to be carried out by two or more discrete interface devices (e.g., an iPhone 4G and a Samsung Galaxy).

Referring again to FIG. 5A, operation 402 may include operation 506 depicting retrieving, from a database provided by a communication network provider, one or more subtasks that correspond to portions of one or more tasks configured to be carried out by two or more discrete interface devices. For example, FIG. 2A shows one-or-more-subtask communication network database retrieving module 206 retrieving, from a database provided by a communication network provider (e.g., a database of subtasks maintained by AT&T including subtasks that AT&T requests to be executed), one or more subtasks (e.g., “measure the 4G signal strength at your location”) that correspond to portions of one or more tasks (e.g., “develop a nationwide 4G coverage map”) configured to be carried out by two or more discrete interface devices (e.g., an iPhone 4G and a Samsung Galaxy).

Referring again to FIG. 5A, operation 402 may include operation 508 depicting retrieving, from a database stored on an interface device, one or more subtasks that correspond to portions of one or more tasks configured to be carried out by two or more discrete interface devices. For example, FIG. 2A shows one-or-more-subtask interface device database retrieving module 208 retrieving, from a database stored on an interface device (e.g., a database of subtasks stored on an iPhone that corresponds to subtasks that iPhone is capable of carrying out based on the status and characteristics of the iPhone), one or more subtasks (e.g., “measure the speed the device is currently moving,”) that correspond to portions of one or more tasks (e.g., “determine how much traffic is currently on I-405”) configured to be carried out by two or more discrete interface devices (e.g., an iPhone at Mile 11 of I-405, and an iPhone at Mile 12 of I-405).

Referring again to FIG. 5A, operation 402 may include operation 510 depicting creating one or more subtasks that correspond to portions of one or more tasks configured to be carried out by two or more discrete interface devices. For example, FIG. 2A shows one-or-more subtask creating module 210 creating one or more subtasks (e.g., “measure ambient noise at a location”) that correspond to portions of one or more tasks (e.g., “determine the loudness of the Pearl Jam concert”) configured to be carried out by two or more discrete interface devices (e.g., a Sony portable recording device, and an iPhone 4).

Referring again to FIG. 5A, operation 402, which may include operation 502 described above, also may include operation 512 depicting creating one or more subtasks that correspond to portions of one or more tasks configured to be carried out by two or more discrete interface devices, wherein the one or more created subtasks are subtasks that were not retrieved in the retrieving operation. For example, FIG. 2A shows one-or-more remaining subtask creation module 212 creating one or more subtasks (e.g., “count the number of cars visible from a camera lens”) that correspond to portions of one or more tasks (e.g., “determine the amount of traffic entering FedEx Field in Washington, D.C.”) configured to be carried out by two or more discrete interface devices (e.g., a backup camera in an OnStar-equipped automobile, and a traffic/speed camera positioned on I-495), wherein the one or more created subtasks are subtasks that were not retrieved in the retrieving operation (e.g., the subtask of “determine whether the interface device position is near I-495” was retrieved already because it had been previously used, or previously stored as a commonly referenced subtask).

Referring to FIG. 5B, operation 402 may include operation 514 depicting generating one or more subtasks that correspond to portions of one or more tasks configured to be carried out by two or more discrete interface devices. For example, FIG. 2A depicts one-or-more subtask generating module 214 generating one or more subtasks (e.g., “determine if there are empty seats on the plane by using the camera”) that correspond to portions of one or more tasks (e.g., “determine if the morning flight from Seattle to Chicago on Alaska Airlines is full,”) configured to be carried out by two or more discrete interface devices (e.g., an ASUS EeePc and an HP Touchpad).

Referring to FIG. 5B, operation 402 may include operation 516 depicting receiving one or more subtasks that correspond to portions of one or more tasks configured to be carried out by two or more discrete interface devices. For example, FIG. 2A depicts one-or-more subtask receiving module 216 receiving one or more subtasks (e.g., Google's servers send out a subtask of “determine the interface device location”) that correspond to portions of one or more tasks (e.g., “determine which area of Seattle has the highest concentration of Android phones”) configured to be carried out by two or more discrete interface devices (e.g., HTC Evo and Motorola Atrix 2).

Referring again to FIG. 5B, operation 402 may include operation 518 depicting transmitting the one or more tasks configured to be carried out by two or more discrete interface devices to a remote location. For example, FIG. 2A depicts remote task transmitting module 218 transmitting the one or more tasks (e.g., “what movie theaters have open seats for Iron Man II”) configured to be carried out by two or more discrete interface devices (e.g., a BlackBerry Bold and a Droid 2) to a remote location (e.g., a Google server that processes the tasks). In some embodiments, the remote location includes a server that processes the received tasks into one or more subtasks, and transmits the received subtasks for receipt and transmission to the interface devices, as will be described in more detail herein.

Specifically, referring again to FIG. 5B, in some embodiments, operation 402 also may include operation 520 depicting receiving the one or more subtasks that correspond to portions of the one or more tasks from the remote location. For example, FIG. 2A depicts remote subtask location receiving module 220 receiving the one or more subtasks (e.g., “transmit the interface device position,” “use the camera to determine how many empty seats are available,” “use the radio to determine how many wireless devices are listening,”) that correspond to portions of the one or more tasks (e.g., “what movie theaters have open seats for Iron Man II”) from the remote location (e.g., the Google server that processes the tasks).

Referring to FIG. 5C, operation 402 may include operation 522 depicting transmitting the one or more tasks configured to be carried out by two or more discrete interface devices to a first remote location. For example, FIG. 2A depicts first remote location task transmitting module 222 transmitting the one or more tasks (e.g., “what restaurants have a Mercer Island view”) configured to be carried out by two or more discrete interface devices (e.g., a HTC Titan and a BlackBerry Torch) to a first remote location (e.g., an Apple server bank storing received information and located in Denver, Colo.). In some embodiments, similarly to as above, the first remote location includes a server that processes the received tasks into one or more subtasks. In some other embodiments, the first remote location performs some of the processing, e.g., pre-processing, e.g., verification or simplification on the transmitted one or more tasks, then transmits the partially processed tasks to a second remote location for further processing. In some further embodiments, the first remote location acts only as a repository, and transmits the tasks to a second remote location for verification and/or processing.

For example, referring again to FIG. 5C, operation 402 may further include operation 524 depicting receiving the one or more subtasks that correspond to portions of the one or more tasks from a second remote location related to the first remote location. For example, FIG. 2A depicts second remote location task receiving module 224 receiving the one or more subtasks (e.g., “determine interface device location,” “determine the view of certain tables at the restaurant by using the camera,” “determine if there are empty tables at the restaurant by using the wireless radio to ping other devices”) that correspond to portions of the one or more tasks (e.g., “what restaurants have a Mercer Island view”) from a second remote location (e.g., a different server bank running Apple's Application Store and located in Manhattan, Kans.”) related to the first remote location (e.g., the Apple server bank storing received information and located in Denver, Colo.).

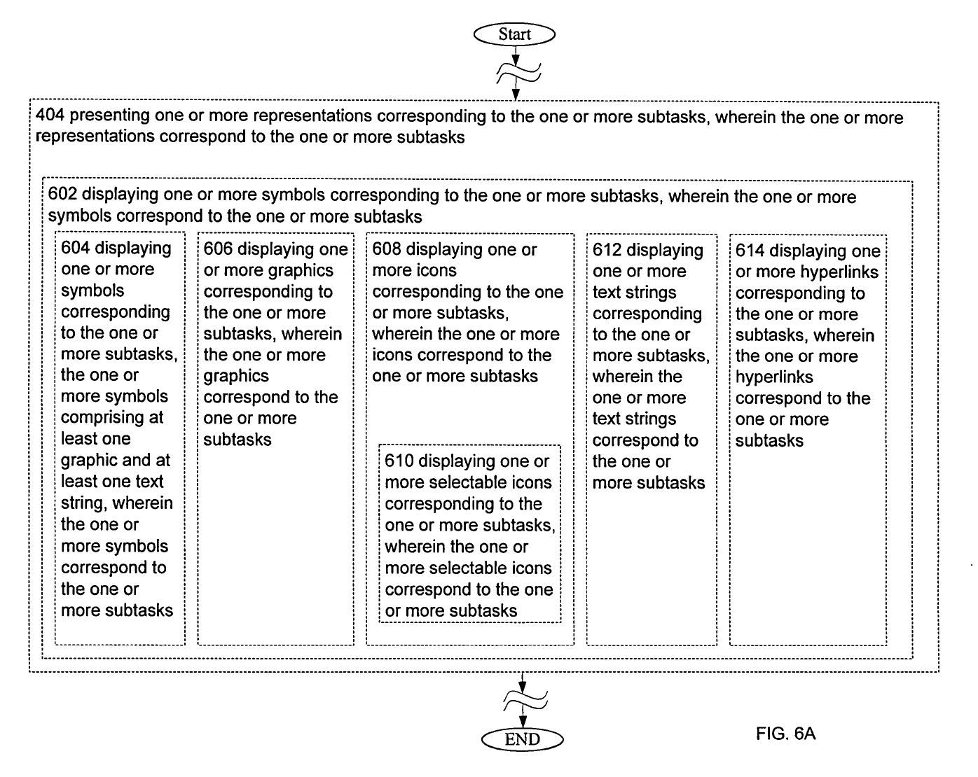

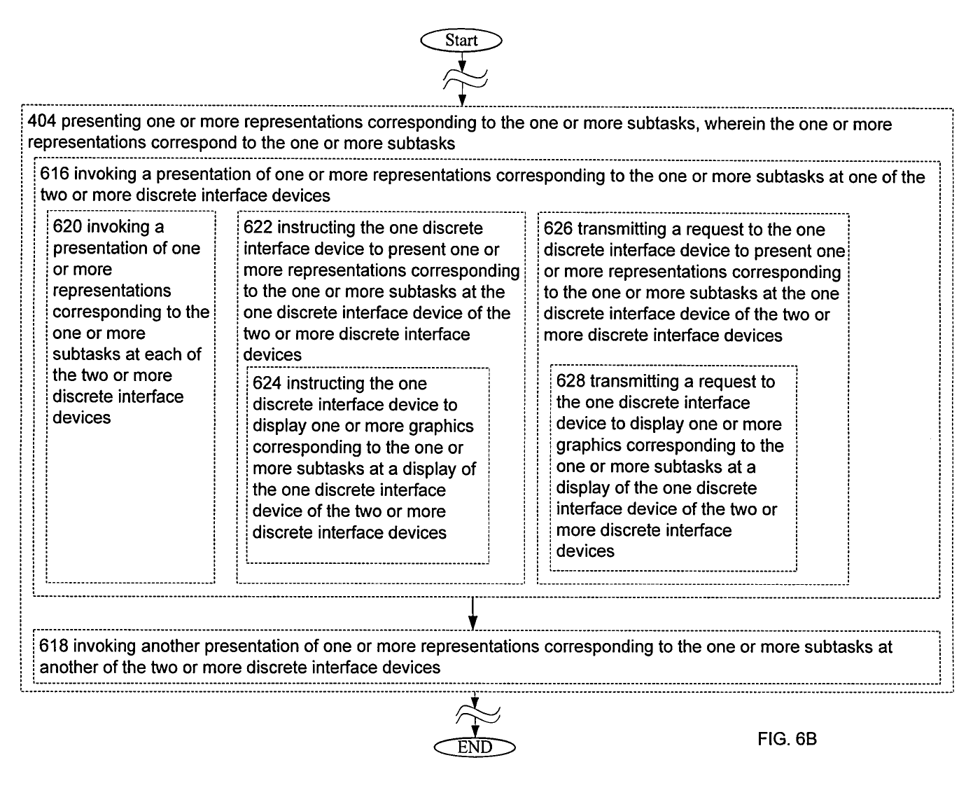

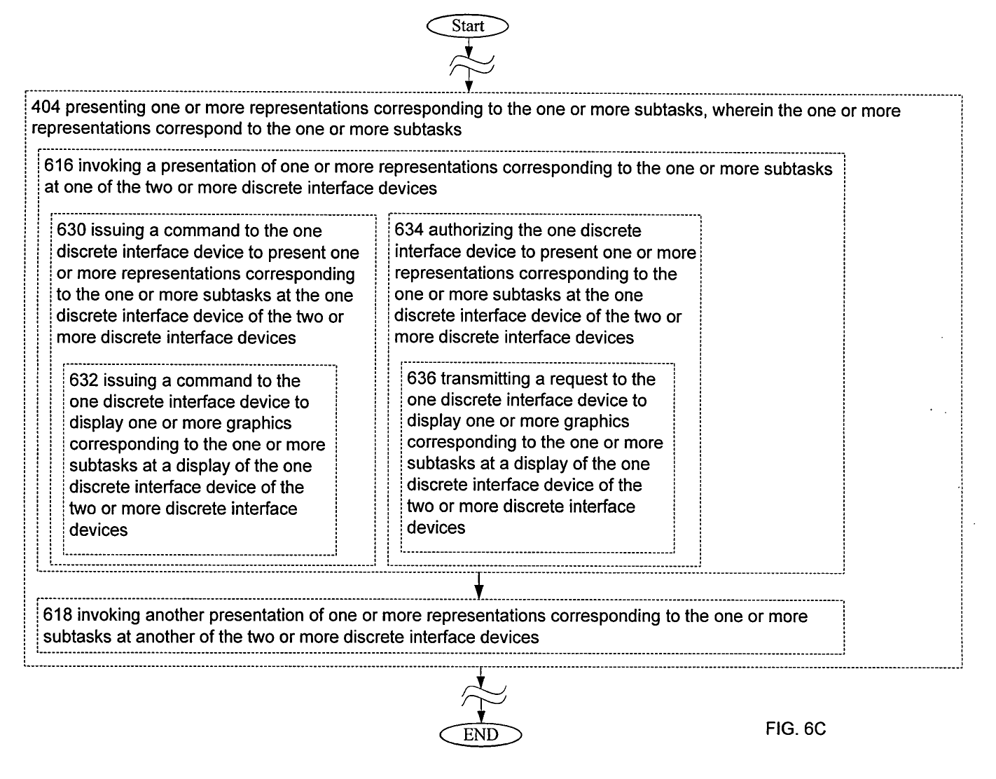

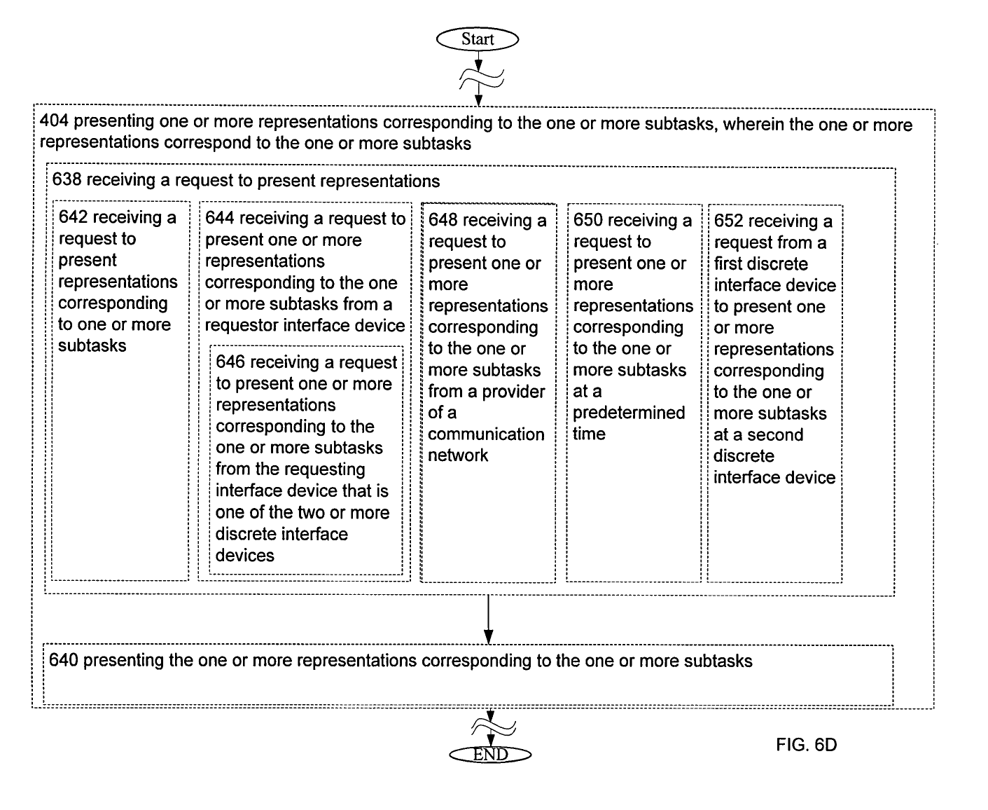

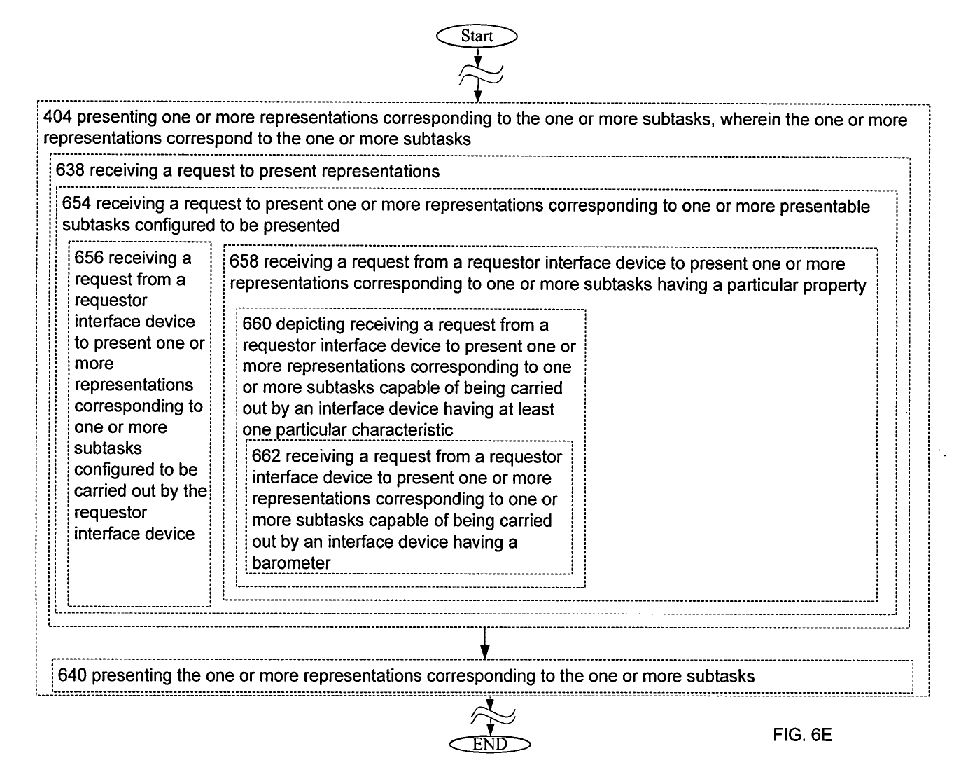

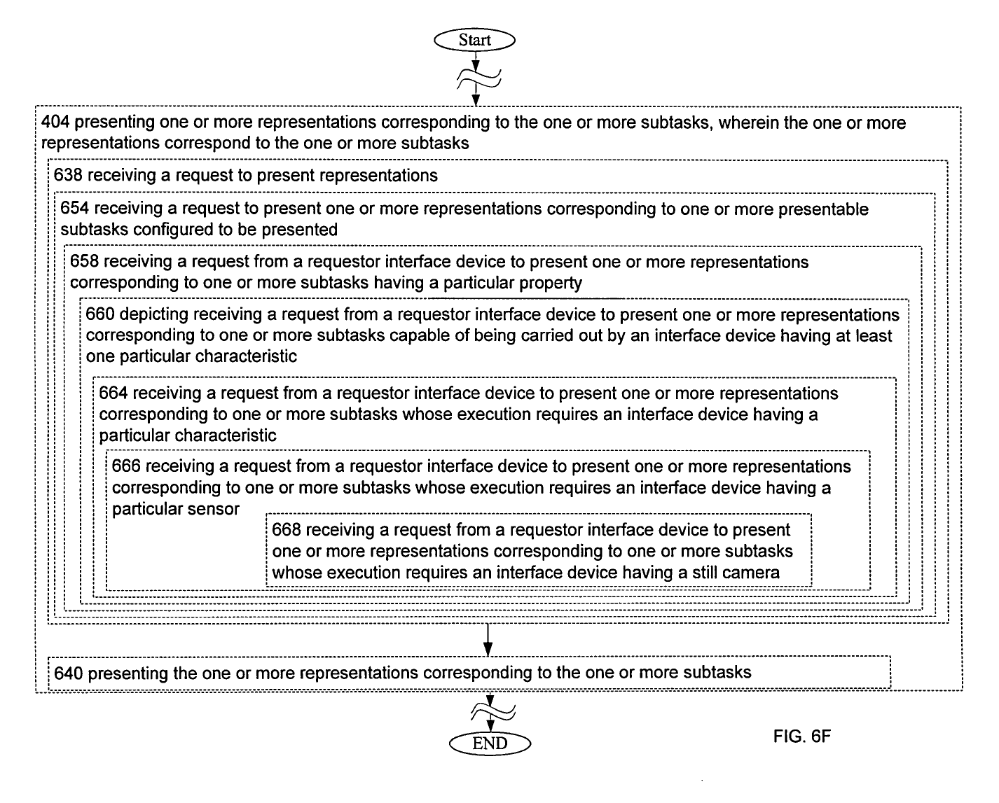

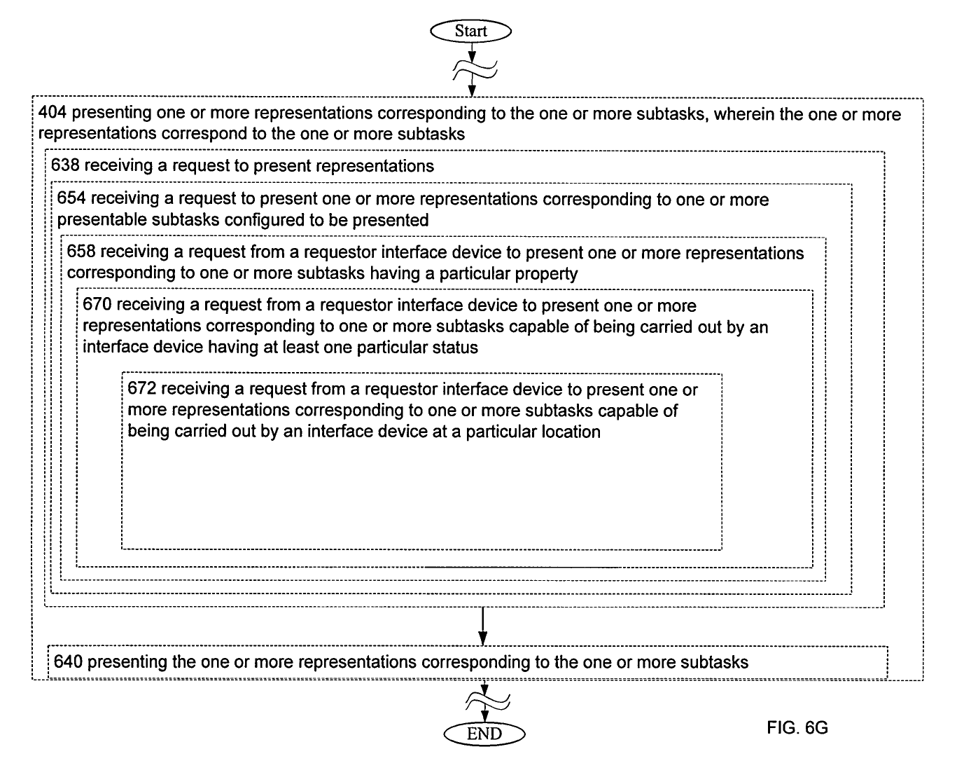

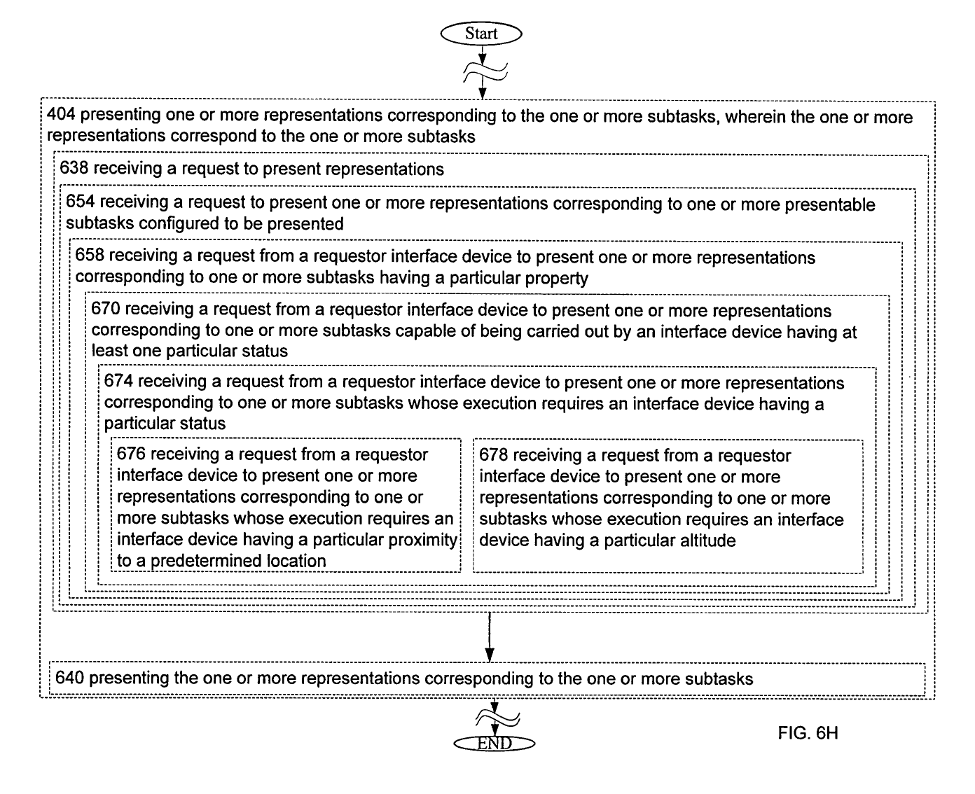

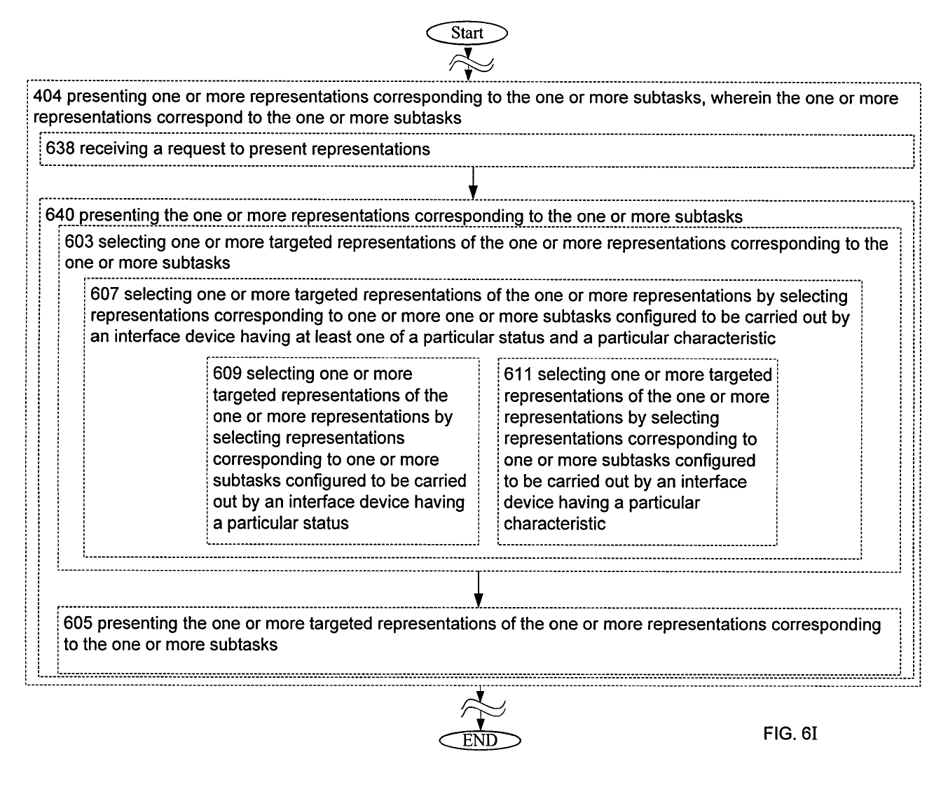

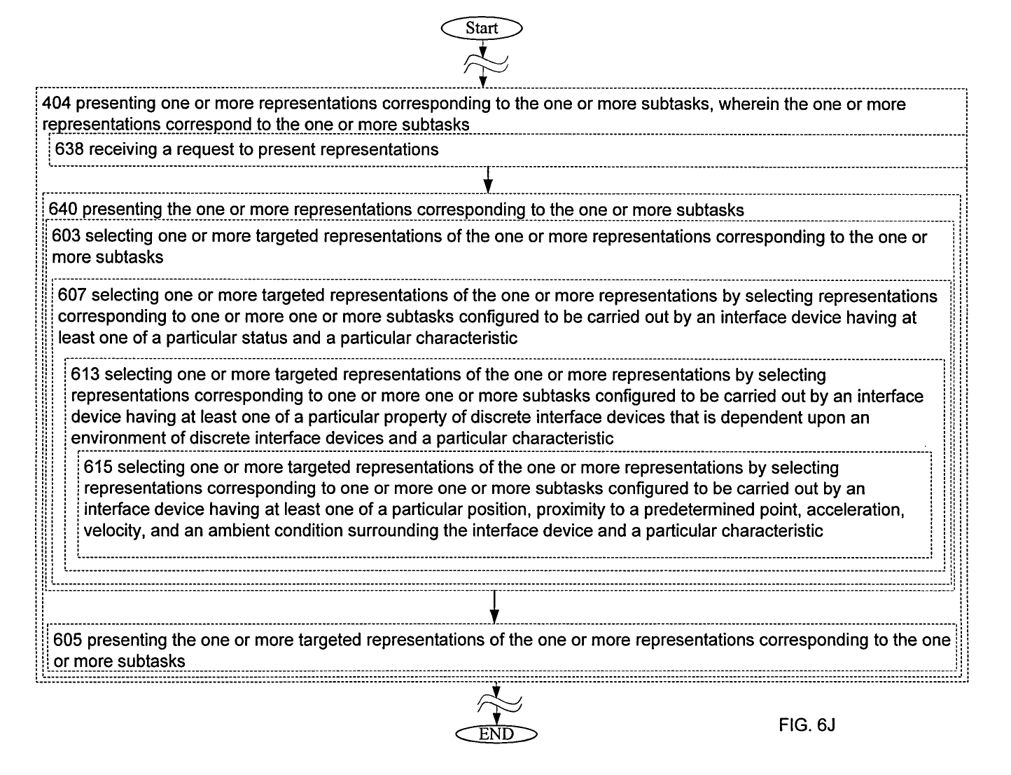

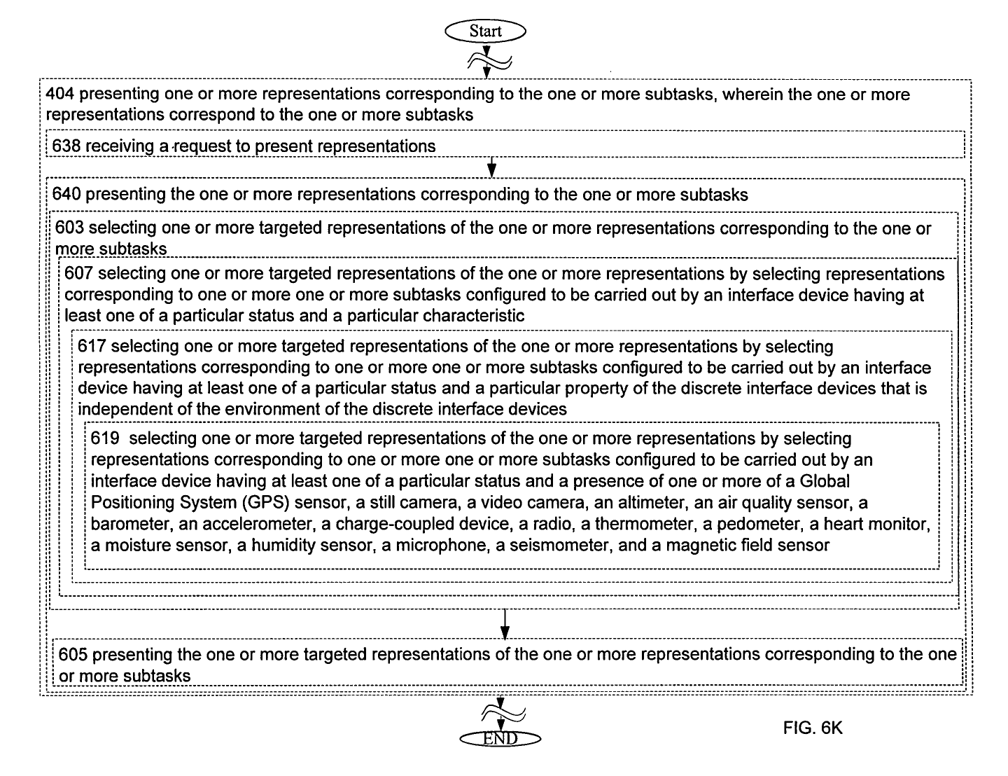

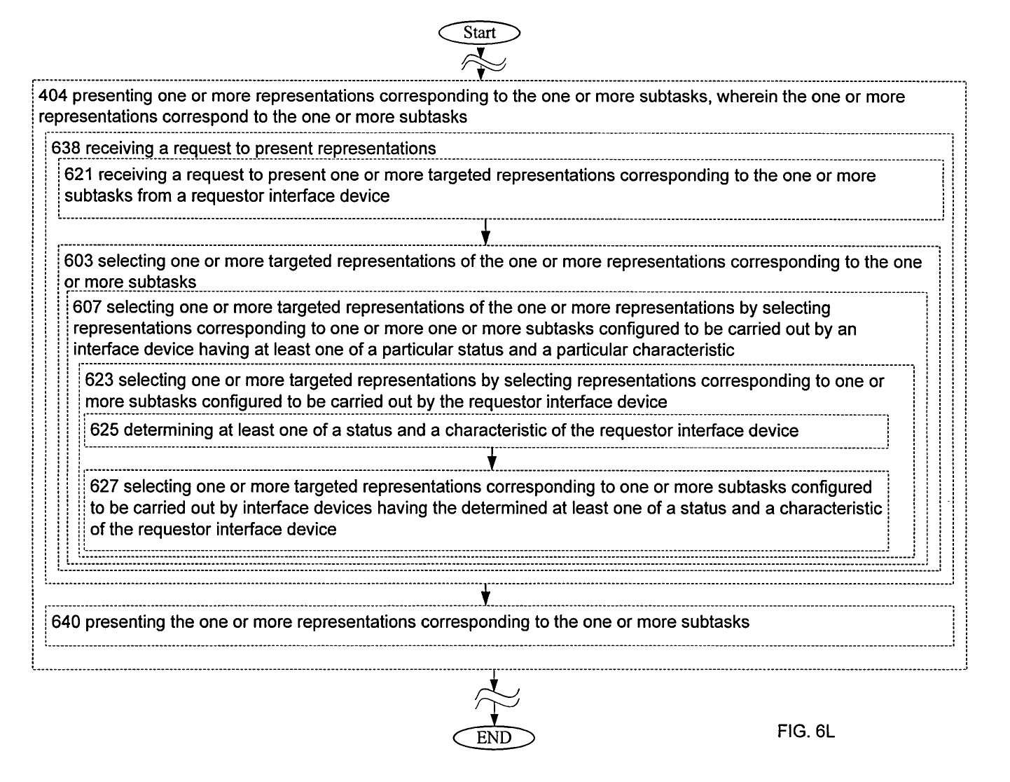

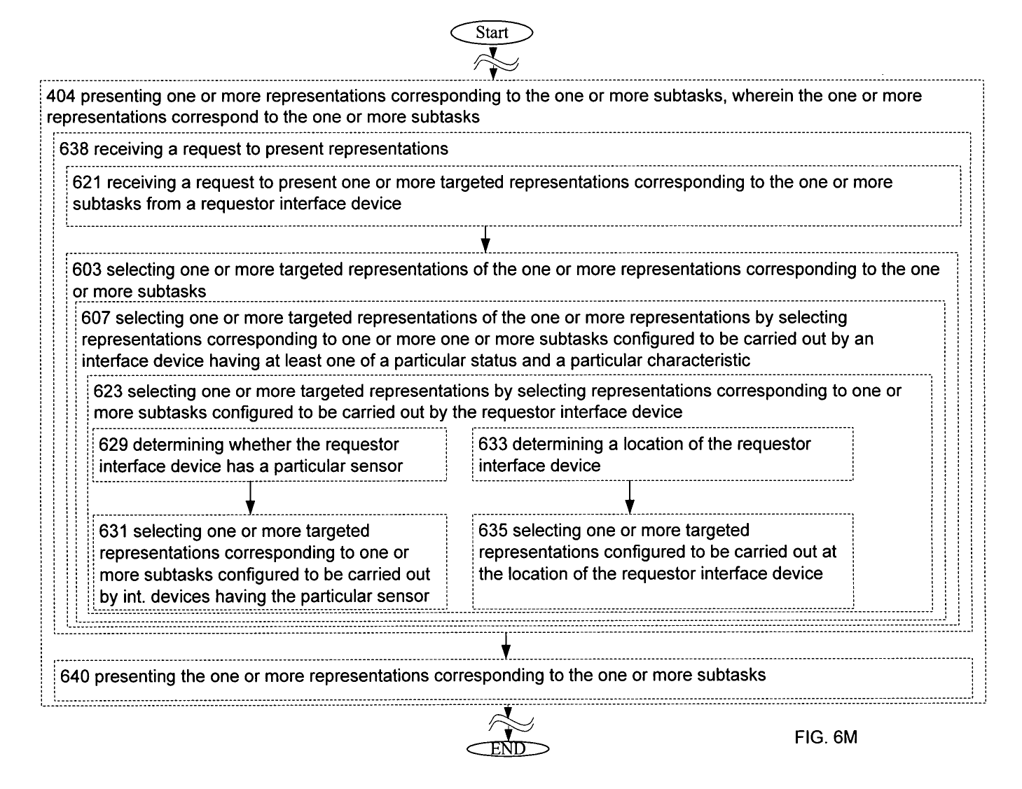

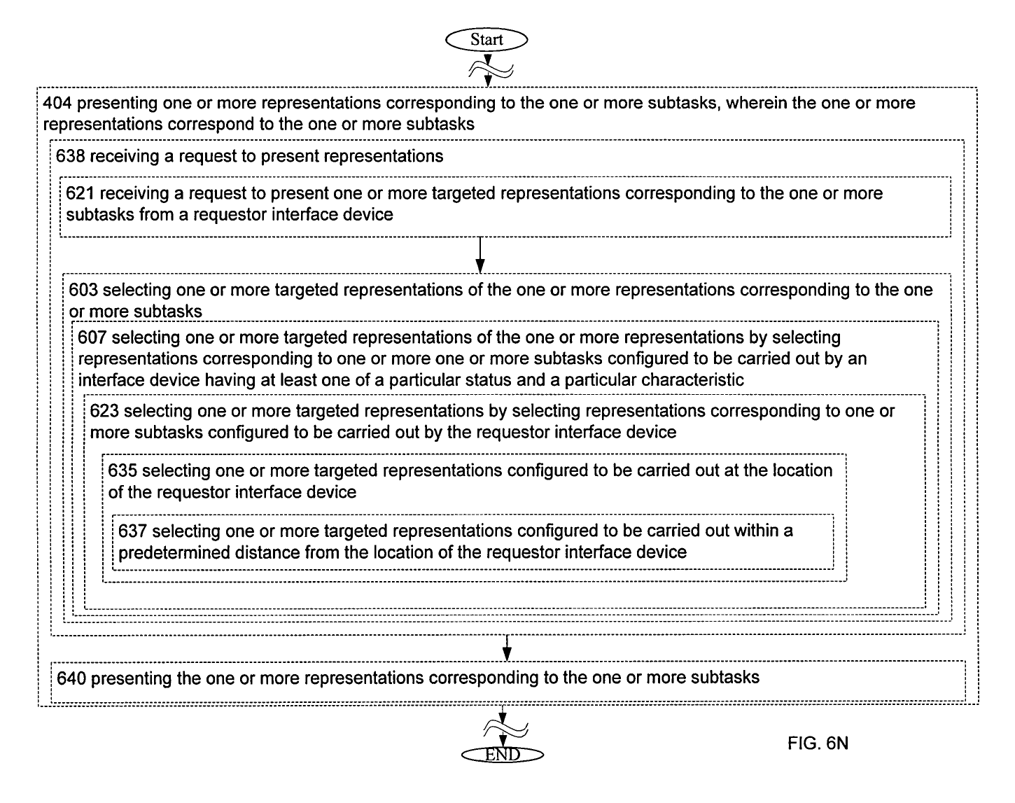

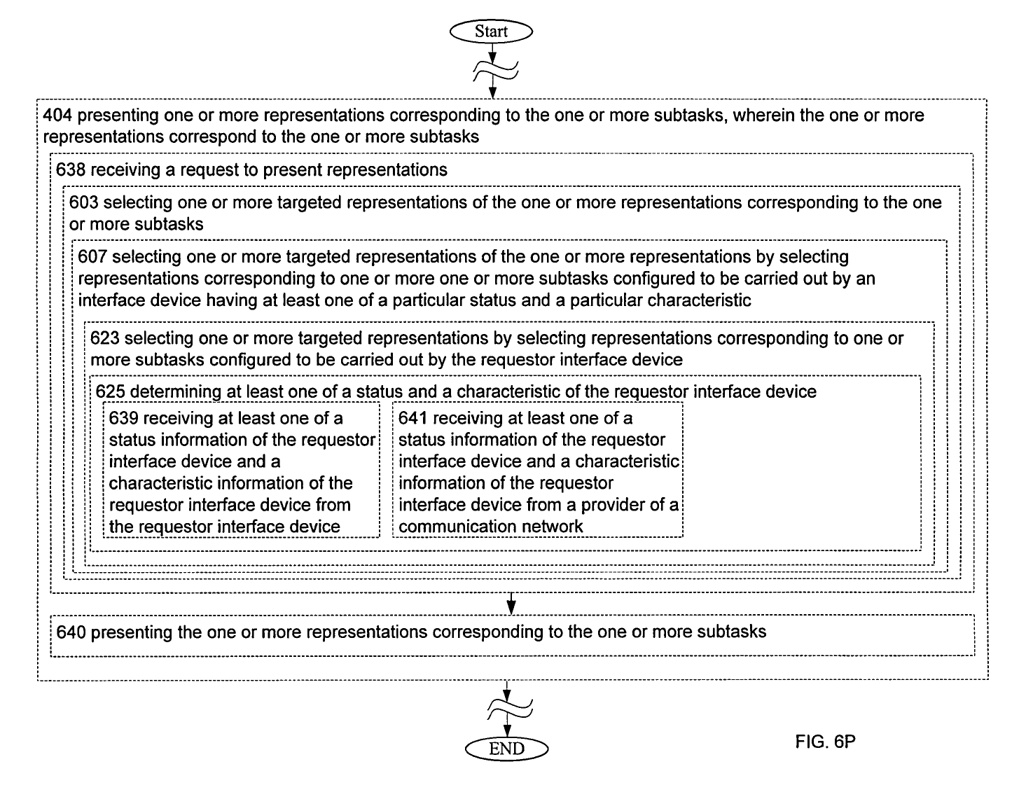

Referring now to FIG. 6A, operation 404 depicting presenting one or more representations corresponding to the one or more subtasks, wherein the one or more representations correspond to the one or more subtasks may include operation 602 depicting displaying one or more symbols corresponding to the one or more subtasks, wherein the one or more symbols correspond to the one or more subtasks. For example, FIG. 2B depicts symbol displaying module 242 displaying one or more symbols (e.g., menu items displayed in a list) corresponding to the one or more subtasks (e.g., “take a picture of the Grand Canyon,” “measure the ambient temperature,” “take a picture of the seat or table next to you,” “hold the interface device up to allow the camera to collect data,”), wherein the one or more symbols correspond to the one or more subtasks (e.g., each menu item corresponds to one of the listed subtasks).

Referring again to FIG. 6A, operation 602 may include operation 604 depicting displaying one or more symbols corresponding to the one or more subtasks, the one or more symbols comprising at least one graphic and at least one text string, wherein the one or more symbols correspond to the one or more subtasks. For example, FIG. 2B depicts corresponding subtask graphic and text string symbol displaying module 244 displaying one or more symbols (e.g., a labeled button) corresponding to the one or more subtasks (e.g., “take a picture of the Space Needle”), the one or more symbols comprising at least one graphic (e.g., the button image) and at least one text string (e.g., the words appearing inside the button image), wherein the one or more symbols correspond to the one or more subtasks (e.g., each button corresponds to one of the subtasks).

Referring again to FIG. 6A, operation 602 may further include operation 606 depicting displaying one or more graphics corresponding to the one or more subtasks, wherein the one or more graphics correspond to the one or more subtasks. For example, FIG. 2B depicts corresponding graphic symbol displaying module 246 displaying one or more graphics (e.g., a miniature camera, a miniature thermometer) corresponding to the one or more subtasks (e.g., “take a picture,” “determine the ambient temperature”), wherein the one or more graphics correspond to the one or more subtasks (e.g., the miniature camera corresponds to “take a picture” and the miniature thermometer corresponds to “take a picture.”).

Referring again to FIG. 6A, operation 602 may further include operation 608 depicting displaying one or more icons corresponding to the one or more subtasks, wherein the one or more icons correspond to the one or more subtasks. For example, FIG. 2B depicts corresponding icon symbol displaying module 248 displaying one or more icons (e.g., stars, where each star is displayed overlaying a map (e.g., a street map, or a city map) and representing a geographical area where a subtask may be carried out) corresponding to the one or more subtasks (e.g., “measure the strength of the 4G signal at Latitude 47.603515, Longitude −122.19119” and “measure the strength of the 4G signal at Latitude 47.60408, −Longitude 122.194129”), wherein the one or more icons correspond to the one or more subtasks (e.g., each star icon corresponds to a subtask of measuring the 4G signal strength at that location).

Referring again to FIG. 6A, operation 608 may further include operation 610 depicting displaying one or more selectable icons corresponding to the one or more subtasks, wherein the one or more selectable icons correspond to the one or more subtasks. For example, FIG. 2B depicts corresponding selectable icon symbol displaying module 250 displaying one or more selectable icons (e.g., a Windows-style camera icon and a Windows-style heart icon that are selectable with a mouse, finger, or other selecting device) corresponding to the one or more subtasks (e.g., “take a picture of the Grand Canyon” and “measure the heart rate of a user of the interface device”), wherein the one or more selectable icons correspond to the one or more subtasks (e.g., the selectable camera icon corresponds to “take a picture of the Grand Canyon” and the selectable heart icon corresponds to “measure the heart rate of a user of the interface device”).

Referring again to FIG. 6A, operation 602 may include operation 612 depicting displaying one or more text strings corresponding to the one or more subtasks, wherein the one or more text strings correspond to the one or more subtasks. For example, FIG. 2B shows corresponding text string symbol displaying module 252 displaying one or more text strings (e.g., “use camera” and “Take a Picture of the Grand Canyon at 8 pm”) corresponding to the one or more subtasks (e.g., “take a picture” and “take a picture of the Grand Canyon at sunset”), wherein the one or more text strings correspond to the one or more subtasks (e.g., the text string “use camera” corresponds to the subtask “take a picture” and the text string “Take a Picture of the Grand Canyon at 8 pm” corresponds to the subtask “take a picture of the Grand Canyon at sunset”). The examples here illustrate the text strings having a direct relationship to the underlying subtasks to which the text strings correspond, but this is done merely for illustrative purposes and is not necessary. In some embodiments, the text string may have no apparent relation to the corresponding subtask, and may be related only via a remotely stored database, or a text string processing algorithm. Moreover, in the above-described embodiment, the text strings were written in a manner to be comprehended by humans; however, this is done merely for illustrative purposes. In some embodiments, the displayed text string may not correspond to English words and expressions.

Referring again to FIG. 6A, operation 602 may include operation 614 depicting displaying one or more hyperlinks corresponding to the one or more subtasks, wherein the one or more hyperlinks correspond to the one or more subtasks. For example, FIG. 2B shows corresponding hyperlink symbol displaying module 254 displaying one or more hyperlinks (e.g., a web page having a list of subtasks, where each subtask in the list is a link to a different page, e.g., a confirmation page) corresponding to the one or more subtasks (e.g., “determine the fog density on Puget Sound”), wherein the one or more hyperlinks correspond to the one or more subtasks (e.g., each hyperlink, links to a page related to the subtask to which the hyperlink corresponds).

Referring now to FIG. 6B, operation 404 may include operation 616 depicting invoking a presentation of one or more representations corresponding to the one or more subtasks at one of the two or more discrete interface devices. For example, FIG. 2B shows discrete interface device presentation invoking module 256 invoking a presentation (e.g., causing a device (e.g., an interface device, (e.g., an iPhone)) to play) one or more representations (e.g., an audible sound (e.g., a tone)) corresponding to the one or more subtasks (e.g., one sound corresponds to “take a picture,” another sound corresponds to “measure the temperature”) at one of the two or more discrete interface devices (e.g., a Droid Bionic). As will be discussed in more detail herein, “invoking a presentation” also may include causing a device to display one or more graphical representations. In addition, the term “invoking a presentation” includes a variety of actions, as will be discussed herein, including, but not limited to, sending instructions of various specificity, sending commands of various priority level, and sending requests of various priority level.

Referring again to FIG. 6B, operation 404 may also include operation 618 depicting invoking another presentation of one or more representations corresponding to the one or more subtasks at another of the two or more discrete interface devices. For example, FIG. 2B shows further discrete interface device presentation invoking module 258 invoking another presentation (e.g., causing a device (e.g., causing a device (e.g., another interface device, (e.g., a BlackBerry)) to display) one or more representations (e.g., a graphical representation (e.g., a picture)) corresponding to the one or more subtasks (e.g., one picture corresponds to “take a picture,” another picture corresponds to “measure the temperature”) at another of the two or more interface devices. In this example, the invoking of the presentation is different depending on the interface device, but in other embodiments, the invocation of the presentation is the same at the one of the two or more discrete interface devices and the another of the two or more discrete interface devices.

Referring again to FIG. 6B, operation 616 may include operation 620 depicting invoking a presentation of one or more representations corresponding to the one or more subtasks at each of the two or more discrete interface devices. For example, FIG. 2B shows each-device discrete interface device presentation invoking module 260 invoking a presentation of one or more representations (e.g., causing a device to display text (e.g., “take a picture,” “measure the ambient light”)) corresponding to the one or more subtasks (e.g. “take a picture of the crowd at Key Arena,” “determine the cloud cover on Mt. Rainier”) at each of the two or more discrete interface devices (e.g., LG G2X, Droid Bionic, Samsung Galaxy SII).

Referring again to FIG. 6B, operation 616 may include operation 622 depicting instructing the one discrete interface device to present one or more representations corresponding to the one or more subtasks at the one discrete interface device of the two or more discrete interface devices. For example, FIG. 2B shows discrete interface device presentation instructing module 262 instructing the one discrete interface device to present one or more representations (e.g., transmitting a “display these designs” instruction to an iPhone) corresponding to the one or more subtasks (e.g., “determine the loudest part of Notre Dame stadium”) at the one discrete interface device (e.g., the iPhone) of the two or more discrete interface devices (e.g., an iPhone and a BlackBerry).

Referring again to FIG. 6B, operation 622 may include operation 624 depicting instructing the one discrete interface device to display one or more graphics corresponding to the one or more subtasks at a display of the one discrete interface device of the two or more discrete interface devices. For example, FIG. 2B shows discrete interface device graphic presentation instructing module 264 instructing the one discrete interface device to display one or more graphics (e.g., transmitting a “display a camera icon and a sun icon” instruction to a device running Android Market) corresponding to the one or more subtasks (e.g., “take a picture of the Hoover Dam” and “measure how bright the sun is on July 5 at Alki Beach”) at a display of the one discrete interface device (e.g., a screen of the HTC Evo 4) of the two or more discrete interface devices (e.g., an HTC Evo 4 and a Pantech Breakout).

Referring again to FIG. 6B, operation 616 may include operation 626 depicting transmitting a request to the one discrete interface device to present one or more representations corresponding to the one or more subtasks at the one discrete interface device of the two or more discrete interface devices. For example, FIG. 2B shows discrete interface device presentation request transmitting module 266 transmitting a request to the one discrete interface device (e.g., transmitting a request signal describing “please present the following representations”) to present one or more representations (e.g., Windows-type icons) corresponding to the one or more subtasks (e.g., “determine which table at the Crab Shack restaurant has the best view of Puget Sound”) at the one discrete interface device (e.g., an HTC Thunderbolt) of the two or more discrete interface devices (e.g., an HTC Thunderbolt and an iPhone).

Referring again to FIG. 6B, operation 626 may include operation 628 depicting transmitting a request to the one discrete interface device to display one or more graphics corresponding to the one or more subtasks at a display of the one discrete interface device of the two or more discrete interface devices. For example, FIG. 2B shows discrete interface device display request transmitting module 268 transmitting a request to the one discrete interface device to display one or more graphics (e.g., transmitting a request signal describing “please display a thermometer graphic, a sun graphic, and a heart graphic”) corresponding to the one or more subtasks (“determine the UV index for Alki beach”) at a display of the one discrete interface device (e.g., the screen of a Google Nexus S) of the two or more discrete interface devices (e.g., the Google Nexus S and the Palm Pre).

Referring now to FIG. 6C, operation 616 may include an operation 630 depicting issuing a command to the one discrete interface device to present one or more representations corresponding to the one or more subtasks at the one discrete interface device of the two or more discrete interface devices. For example, FIG. 2B shows discrete interface device presentation command issuing module 270 issuing a command to the one discrete interface device (e.g., sending an imperative as an interrupt (e.g., as a command that requires the interface device to prioritize the presentations)) to present one or more representations (e.g., a thermometer icon, a sun icon, and a teddy bear icon) corresponding to the one or more subtasks (e.g., determining a temperature, determining a heat index, and determining a wildlife activity count) at the one discrete interface device (e.g., an iPad) of the two or more discrete interface devices (e.g., an iPad, a Garmin GPS, and a weather station).

Referring again to FIG. 6C, operation 630 may include an operation 632 depicting issuing a command to the one discrete interface device to display one or more graphics corresponding to the one or more subtasks at a display of the one discrete interface device of the two or more discrete interface devices. For example, FIG. 2B depicts discrete interface device display command issuing module 272 issuing a command to the one discrete interface device (e.g., sending an imperative as an interrupt (e.g., as a command that requires the interface device to prioritize the presentations)) to display one or more graphics (e.g., a 3D picture of a thermometer and a 3D picture of a compass) corresponding to the one or more subtasks (e.g., determining a temperature, and determining a heading based on position and velocity) at the one discrete interface device (e.g., an ASUS EeePc) of the two or more discrete interface devices (e.g., an ASUS EeePc and an OnStar system).

Referring again to FIG. 6C, operation 616 may include operation 634 depicting authorizing the one discrete interface device to present one or more representations corresponding to the one or more subtasks at the one discrete interface device of the two or more discrete interface devices. For example, FIG. 2B depicts discrete interface device presentation authorization module 274 authorizing the one discrete interface device (e.g., transmitting an authorization code to access an encrypted piece of data containing the representations or pointers to the representations) to present one or more representations (e.g., Apple Store-style icons) corresponding to the one or more subtasks (e.g., “measure the air quality”) at the one discrete interface device (e.g., the iPhone 3G) of the two or more discrete interface devices (e.g., the iPhone 3G and the ASUS Transformer).

Referring again to FIG. 6C, operation 634 may include operation 636 depicting authorizing the one discrete interface device to display one or more graphics corresponding to the one or more subtasks at a display of the one discrete interface device of the two or more discrete interface devices. For example, FIG. 2B shows discrete interface device graphic authorization module 276 authorizing the one discrete interface device (e.g., transmitting an access code to access stored data containing the representations or pointers to the representations) to present one or more representations (e.g., Android Market-style icons) corresponding to the one or more subtasks (e.g., “determine visibility at 6000 feet altitude”) at the one discrete interface device (e.g., Motorola Droid 2) of the two or more discrete interface devices (e.g., the Motorola Droid 2 and the ASUS Transformer).

Referring now to FIG. 6D, operation 404 may include operation 638 depicting receiving a request to present representations. For example, FIG. 2B shows representation presentation request receiving module 278 receiving a request to present representations (e.g., an iPhone sends a request to display available subtasks on the iPhone screen). The request may be broad, e.g., a request to show many subtasks, or narrow, e.g., show me only subtasks using the camera. As will be discussed in more detail herein, the subtasks whose presentation is invoked at the interface device are selected through a variety of methods.

Referring again to FIG. 6D, operation 404 may further include operation 640 depicting presenting the one or more representations corresponding to the one or more subtasks. For example, FIG. 2B shows corresponding subtask representation presentation 280 presenting the one or more representations (e.g., causing the iPhone to display the available subtasks on the iPhone screen) corresponding to the one or more subtasks (e.g., “take a picture of Bob's Barista,” “measure the humidity inside Bill's Cigar Shop.”

Referring again to FIG. 6D, operation 638 may further include operation 642 depicting device receiving. For example, FIG. 2B shows subtask representation presentation request receiving module 282 receiving a request to present one or more representations (e.g., a Dell laptop accesses a subtask website, which sends a request to present subtask hyperlinks) corresponding to the one or more subtasks (e.g., “determine the view from Seat 34B, Section 112 in Safeco field”).

Referring again to FIG. 6D, operation 638 may further include operation 644 depicting receiving a request to present one or more representations corresponding to the one or more subtasks from a requestor interface device. For example, FIG. 2B shows subtask representation interface device request receiving module 284 receiving a request to present one or more representations (e.g., a request is received from a Dell desktop that executed a program stored on the hard drive, which transmitted a request to present graphics corresponding to subtasks) corresponding to the one or more subtasks (e.g., “determine whether the North Star is visible at 3 am from the present location”).

Referring again to FIG. 6D, operation 644 may include operation 646 depicting receiving a request to present one or more representations corresponding to the one or more subtasks from the requesting interface device that is one of the two or more discrete interface devices. For example, FIG. 2B shows requestor interface device representation presentation request receiving module 286 receiving a request to present one or more representations (e.g., an iPad accesses an application store, which retrieves touchscreen-selectable representations including a camera icon and an ink pen icon) corresponding to the one or more subtasks (e.g., “take a picture of the car dealership on 34^{th} and G street”) from the requesting interface device (e.g., the iPad that accesses the application store) that is one of the two or more discrete interface devices (e.g., the iPad, another iPad, and a TomTom Navigation system).

Referring again to FIG. 6D, operation 644 may include operation 648 depicting receiving a request to present one or more representations corresponding to the one or more subtasks from a provider of a communication network. For example, FIG. 2B shows communication network provider representation presentation request receiving module 288 receiving a request to present one or more representations (e.g., a request is received from AT&T requesting that one or more representations be presented to interface devices on AT&T's network) corresponding to the one or more subtasks (e.g., “measure the wireless signal strength at your current location”) from a provider of a communication network (e.g., AT&T).

Referring again to FIG. 6D, operation 644 may include operation 650 depicting receiving a request to present one or more representations corresponding to the one or more subtasks at a predetermined time. For example, FIG. 2B shows representation presentation request at a particular time receiving module 290 receiving a request (e.g., a received request from a user's personal computer to present one or more representations on the user's cell phone at 8 pm that night) to present one or more representations (e.g., a lamp icon) corresponding to the one or more subtasks (e.g., “measure the brightness of the dining area at Dorsia”) at a predetermined time, e.g., at 8 pm that night, when the user and the user's cell phone will be at the restaurant).

Referring again to FIG. 6D, operation 644 may include operation 652 depicting receiving a request from a first discrete interface device to present one or more representations corresponding to the one or more subtasks at a second discrete interface device. For example, FIG. 2B shows different-device representation presentation request receiving module 292 receiving a request from a first discrete interface device (e.g., a received request from a user's Dell home PC) to present one or more representations (e.g., a graphic of a sun setting over mountains) corresponding to the one or more subtasks (e.g., determine a time when the outside ambient light drops below 50%) at a second discrete interface device (e.g., present the representations on an HP laptop located at an office building remote from the user's Dell home PC).

Referring now to FIG. 6E, operation 644 may include operation 654 depicting receiving a request to present one or more representations corresponding to one or more presentable subtasks configured to be presented. For example, FIG. 2B shows presentable corresponding subtask representation presentation request receiving module 294 receiving a request to present one or more representations (e.g., a thermometer icon and a compass icon) corresponding to one or more presentable subtasks (e.g., “measure the temperature,” and “determine the position”) configured to be presented (e.g., the requesting interface device may have only a temperature gauge and a GPS sensor, and thus only temperature and position related tasks are presentable).

Referring now to FIG. 6E, operation 654 may include operation 656 depicting receiving a request from a requestor interface device to present one or more representations corresponding to one or more subtasks configured to be carried out by the requestor interface device. For example, FIG. 2B shows requestor capable corresponding subtask representation presentation request receiving module 296 receiving a request from a requestor interface device (e.g., a GM truck entertainment system) to present one or more representations (e.g., a fog density icon) corresponding to one or more subtasks (e.g., “determine fog density on I-90”) configured to be carried out by the requestor interface device (e.g., the GM truck has fog lights and a light detection sensor calibrated to determine how much of the outgoing light is reflected back by the fog).

Referring again to FIG. 6E, operation 654 may include operation 658 depicting receiving a request from a requestor interface device to present one or more representations corresponding to one or more subtasks having a particular property. For example, FIG. 2B shows particular property corresponding subtask representation presentation request receiving module 298 receiving a request from a requestor interface device (e.g., a Samsung Galaxy Tab) to present one or more representations (e.g., display a Coke can icon) corresponding to one or more subtasks (e.g., “determine whether the restaurant at the present location carries Coca-Cola products”) having a particular property (e.g., a property of “can be performed in restaurants”).

Referring again to FIG. 6E, operation 658 may include operation 660 depicting receiving a request from a requestor interface device to present one or more representations corresponding to one or more subtasks capable of being carried out by an interface device having at least one particular characteristic. For example, FIG. 2B shows particular characteristic subtask request receiving module 310 receiving a request from a requestor interface device (e.g., BlackBerry Bold) to present one or more representations (e.g., to display selectable icons on the BlackBerry Bold screen) corresponding to one or more subtasks (e.g., determine the strength of the Wi-Fi signal at Barnes and Noble) capable of being carried out by an interface device having at least one particular characteristic (e.g., the BlackBerry Bold that has a Wi-Fi radio).

Referring again to FIG. 6E, operation 660 may include operation 662 depicting receiving a request from a requestor interface device to present one or more representations corresponding to one or more subtasks capable of being carried out by an interface device having a barometer. For example, FIG. 2B shows barometric interface device subtask representation presentation request receiving module 312 receiving a request from a requestor interface device (e.g., BlackBerry Bold) to present one or more representations (e.g., to display selectable icons on the BlackBerry Bold screen) corresponding to one or more subtasks (e.g., determine the barometric pressure at a current location) capable of being carried out by an interface device having at least one particular characteristic (e.g., the BlackBerry Bold that has a barometer).

Referring to FIG. 6F, operation 660 may include operation 664 depicting receiving a request from a requestor interface device to present one or more representations corresponding to one or more subtasks whose execution requires an interface device having a particular characteristic. For example, FIG. 2B shows required characteristic subtask request receiving module 314 receiving a request from a requestor interface device (e.g., a Nokia E5 smart phone with an air quality sensor) to present one or more representations (e.g., low-resolution icons) corresponding to one or more subtasks (e.g., “determine a mold spore count in the air at the location,” “determine bee pollen levels”) whose execution requires an interface device having a particular characteristic (e.g., the Nokia E5 with the air quality sensor, an air quality sensor is required to carry out the determination of the mold spore count and bee pollen levels).

Referring again to FIG. 6F, operation 664 may include operation 666 depicting receiving a request from a requestor interface device to present one or more representations corresponding to one or more subtasks whose execution requires an interface device having a particular sensor. For example, FIG. 2B shows required sensor subtask request receiving module 316 receiving a request from a requestor interface device (e.g., a Nike Heart Monitor SportWatch) to present one or more representations (e.g., LCD bars) corresponding to one or more subtasks (e.g., “measure average heart rate for one minute,” “measure peak heart rate over a sixty-minute period”) whose execution requires an interface device having a particular sensor (e.g., a Nike watch with a heart rate monitor, without the heart rate monitor, the requested subtasks could not be carried out).

Referring again to FIG. 6F, operation 666 may include operation 668 depicting receiving a request from a requestor interface device to present one or more representations corresponding to one or more subtasks whose execution requires an interface device having a still camera. For example, FIG. 2B shows still camera sensor subtask request receiving module 318 receiving a request from a requestor interface device (e.g., a Canon EOS Rebel camera) to present one or more representations (e.g., icons capable of being overlaid on a digital viewfinder) corresponding to one or more subtasks (e.g., “measure the light available from a particular location,” “capture an image of a parking garage in a particular location”) whose execution requires an interface device (e.g., the Canon EOS Rebel camera) having a still camera.

Referring now to FIG. 6G, operation 658 may include operation 670 depicting receiving a request from a requestor interface device to present one or more representations corresponding to one or more subtasks capable of being carried out by an interface device having at least one particular status. For example, FIG. 2B shows capable status interface device subtask representation presentation request receiving module 320 receiving a request from a requestor interface device (e.g., an iPod Touch) to present one or more representations (e.g., Apple-type icons) corresponding to one or more subtasks (e.g., “determine the velocity if the device is moving above 15 miles per hour”) capable of being carried out by an interface device having at least one particular status (e.g., velocity >15 mph, e.g., being transported by some type of vehicle).

Referring again to FIG. 6G, operation 670 may include operation 672 depicting receiving a request from a requestor interface device to present one or more representations corresponding to one or more subtasks capable of being carried out by an interface device at a particular location. For example, FIG. 2B shows particular location corresponding subtask representation presentation request receiving module 322 receiving a request from a requestor interface device (e.g., a Palm Pre) to present one or more representations (e.g., Windows-style icons representing the various sensors) corresponding to one or more subtasks (e.g., measure the humidity, temperature, ground wetness at a particular location) capable of being carried out by an interface device at a particular location (e.g., the 16^{th} hole of Avondale golf course).

Referring now to FIG. 6H, operation 670 may include operation 674 depicting receiving a request from a requestor interface device to present one or more representations corresponding to one or more subtasks whose execution requires an interface device having a particular status. For example, FIG. 2B shows required status interface device subtask representation presentation request receiving module 324 receiving a request from a requestor interface device (e.g., an HP TouchPad) to present one or more representations (e.g., Windows-style icons with text identifiers below them) corresponding to one or more subtasks (e.g., determine when the sun completely slips below Puget Sound when looking out from Mukilteo) whose execution requires an interface device having a particular status (e.g., is present at a time when the sun is setting).

Referring again to FIG. 6H, operation 674 may include operation 676 depicting receiving a request from a requestor interface device to present one or more representations corresponding to one or more subtasks whose execution requires an interface device having a particular proximity to a predetermined location. For example, FIG. 2B shows predetermined location corresponding subtask representation presentation request receiving module 326 receiving a request from a requestor interface device (e.g., Pantech Breakout) to present one or more representations (e.g., selectable icons visible at lower resolutions) corresponding to one or more subtasks (e.g., “take a picture of Times Square”) whose execution requires an interface device having a particular proximity to a predetermined location (e.g., the Pantech Breakout must be within 100 meters of Times Square to obtain a quality picture). In some embodiments, the proximity to the predetermined location may vary based on the type of interface device. For example, a digital camera with a zoom lens may require less proximity to the predetermined location than a cellular phone with a basic camera.

Referring again to FIG. 6H, operation 674 may include operation 678 depicting receiving a request from a requestor interface device to present one or more representations corresponding to one or more subtasks whose execution requires an interface device having a particular altitude. For example, FIG. 2B shows particular altitude corresponding subtask representation presentation request receiving module 328 receiving a request from a requestor interface device (e.g., an HTC Flyer) to present one or more representations (e.g., selectable icons) corresponding to one or more subtasks (e.g., “determine visibility from the top of the Space Needle,” “determine at which altitude the Space Needle is visible from Mt. Rainier”) whose execution requires an interface device having a particular altitude (e.g., “atop the Space Needle” or “more than 1000 feet above sea level”).

Referring now to FIG. 61, operation 640 may include operation 603 depicting selecting one or more targeted representations of the one or more representations corresponding to the one or more subtasks. For example, FIG. 2B shows requestor interface device representation presentation request receiving module 340 selecting one or more targeted representations (e.g., icons corresponding to subtasks that are related to Fry's Electronics, e.g., a television icon corresponding to “what type of TVs are on display at the Fry's electronics on 37^{th} street” and a stopwatch icon corresponding to “how long is the wait at the returns counter for the Fry's in Bellevue, Wash.”) of the one or more representations corresponding to the one or more subtasks.

Referring again to FIG. 61, operation 640 may further include operation 605 depicting presenting the one or more targeted representations of the one or more representations corresponding to the one or more subtasks. For example, FIG. 2B shows targeted corresponding subtask representation presentation module 342 presenting the one or more targeted representations (e.g., displaying the icons corresponding to subtasks that are related to Fry's Electronics, e.g., a television icon corresponding to “what type of TVs are on display at the Fry's electronics on 37^{th} street” and a stopwatch icon corresponding to “how long is the wait at the returns counter for the Fry's in Bellevue, Wash.”) of the one or more representations corresponding to the one or more subtasks.

Referring again to FIG. 61, operation 603 may include operation 607 depicting selecting one or more targeted representations of the one or more representations by selecting representations corresponding to one or more subtasks configured to be carried out by an interface device having at least one of a particular status and a particular characteristic. For example, FIG. 2B shows particular status and/or characteristic interface device targeted representation selecting module 344 selecting one or more targeted representations (e.g., icons representing “determine the strength of the wireless network at Subway,” “determine the strength of the wireless network at McDonalds”) of the one or more representations by selecting representations corresponding to one or more subtasks configured to be carried out by an interface device (e.g., an iPhone) having at least one of a particular status and a particular characteristic (e.g., has a characteristic of having a wireless radio)

Referring again to FIG. 61, operation 607 may include operation 609 depicting selecting one or more targeted representations of the one or more representations by selecting representations corresponding to one or more subtasks configured to be carried out by an interface device having a particular status. For example, FIG. 2B shows particular status interface device targeted representation selecting module 346 selecting one or more targeted representations (e.g., icons corresponding to “determine a visibility of Puget Sound from Tully's Coffee Shop,” “determine a 4G signal strength from Tully's coffee shop,” “determine the concentration of vanilla extract in Tully's extra-strong vanilla-flavored coffee”) of the one or more representations by selecting representations corresponding to one or more subtasks configured to be carried out by an interface device having a particular status (e.g., a status of “is located within a Tully's Coffee Shop”).

Referring again to FIG. 61, operation 607 may include operation 611 depicting selecting one or more targeted representations of the one or more representations by selecting representations corresponding to one or more subtasks configured to be carried out by an interface device having a particular characteristic. For example, FIG. 2B shows particular characteristic interface device targeted representation selecting module 348 selecting one or more targeted representations (e.g., icons corresponding to “determine a visibility of Puget Sound from Tully's Coffee Shop,” “take a picture of the view from the Space Needle,” “take a picture of the field view from Section 304 of Safeco Park”) of the one or more representations by selecting representations corresponding to one or more subtasks configured to be carried out by an interface device having a particular characteristic (e.g., a characteristic of “has a camera”).

Referring now to FIG. 6J, operation 607 may include operation 613 depicting selecting one or more targeted representations of the one or more representations by selecting representations corresponding to one or more subtasks configured to be carried out by an interface device having at least one of a particular property of discrete interface devices that is dependent upon an environment of discrete interface devices and a particular characteristic. For example, FIG. 2B shows environment-dependent particular interface device targeted representation selecting module 350 selecting one or more targeted representations (e.g., icons corresponding to “determine the visibility of the North Star at a location”) of the one or more representations by selecting representations corresponding to one or more subtasks configured to be carried out by an interface device (e.g., a BlackBerry 8800) having at least one of a particular property of discrete interface devices that is dependent upon an environment of discrete interface devices (e.g., “is located at a position at which it is night and stars are visible”) and a particular characteristic (e.g., “has a camera”).

Referring again to FIG. 6J, operation 613 may include operation 615 depicting selecting one or more targeted representations of the one or more representations by selecting representations corresponding to one or more subtasks configured to be carried out by an interface device having at least one of a particular position, proximity to a predetermined point, acceleration, velocity, and an ambient condition surrounding the interface device and a particular characteristic. For example, FIG. 2B shows specific status interface device targeted representation selecting module 352 selecting one or more targeted representations (e.g., icons corresponding to “determine the speed that the interface device is moving”) of the one or more representations by selecting representations corresponding to one or more subtasks (e.g., “determine how fast traffic is moving on I-405”) configured to be carried out by an interface device having at least one of a particular position, proximity to a predetermined point, acceleration, velocity, and an ambient condition surrounding the interface device (e.g., the interface device is positioned on I-405) and a particular characteristic (e.g., the interface device has a velocity detector).

Referring now to FIG. 6K, operation 607 may include operation 617 depicting selecting one or more targeted representations of the one or more representations by selecting representations corresponding to one or more subtasks configured to be carried out by an interface device having at least one of a particular status and a particular property of the discrete interface devices that is independent of the environment of the discrete interface devices. For example, FIG. 2B shows environment-independent particular interface device targeted representation selecting module 354 selecting one or more targeted representations (e.g., icons corresponding to “determine the heart rate of the person over a period of time (e.g., to determine the most intense portions of a movie)) corresponding to one or more subtasks configured to be carried out by an interface device having at least one of a particular status (e.g., the interface device is positioned next to a user's body and located within a movie theater) and a particular property of the discrete interface devices that is independent of the environment of the discrete interface devices (e.g., the interface device has a heart rate monitor).

Referring again to FIG. 6K, operation 617 may include operation 619 depicting selecting one or more targeted representations of the one or more representations by selecting representations corresponding to one or more subtasks configured to be carried out by an interface device having at least one of a particular status and a presence of one or more of a Global Positioning System (GPS) sensor, a still camera, a video camera, an altimeter, an air quality sensor, a barometer, an accelerometer, a charge-coupled device, a radio, a thermometer, a pedometer, a heart monitor, a moisture sensor, a humidity sensor, a microphone, a seismometer, and a magnetic field sensor. For example, FIG. 2B shows specific characteristic interface device targeted representation selecting module 356 selecting one or more targeted representations (e.g., icons corresponding to “determine how far away the 700 WLW Cincinnati radio station can be heard”) of the one or more representations by selecting representations corresponding to one or more subtasks configured to be carried out by an interface device (e.g., a Sony Walkman) having at least one of a particular status and a presence of one or more of a Global Positioning System (GPS) sensor, a still camera, a video camera, an altimeter, an air quality sensor, a barometer, an accelerometer, a charge-coupled device, a radio, a thermometer, a pedometer, a heart monitor, a moisture sensor, a humidity sensor, a microphone, a seismometer, and a magnetic field sensor (e.g., the Sony Walkman has a radio).

Referring now to FIG. 6L, operation 638 may include operation 621 depicting receiving a request to present one or more targeted representations corresponding to the one or more subtasks from a requestor interface device. For example, FIG. 2B shows requestor interface device representation presentation request receiving module 358 receiving a request to present one or more targeted representations (e.g., receiving a request from an iPhone to cause icons to be displayed corresponding to tasks that use the GPS location sensor) corresponding to the one or more subtasks (e.g., “determine the position”) from a requestor interface device (e.g., the iPhone).

Referring again to FIG. 6L, operation 607 of operation 638 may include operation 623 depicting selecting one or more targeted representations by selecting representations corresponding to one or more subtasks configured to be carried out by the requestor interface device. For example, FIG. 2B shows requestor interface device targeted representation corresponding subtask selecting module 360 selecting one or more targeted representations (e.g., icons corresponding to “determine the acidity of the soda pop served at the Factoria movie theater”) by selecting representations corresponding to one or more subtasks configured to be carried out by the requestor interface device (e.g., a smartphone that has a pH meter is the requestor interface device).

Referring again to FIG. 6L, operation 623 may include operation 625 depicting determining at least one of a status and a characteristic of the requestor interface device. For example, FIG. 2B shows requestor interface device determining module 362 determining (e.g., receiving information about an interface device) at least one of a status and a characteristic (e.g., a location) of the requestor interface device (e.g., a Samsung Galaxy SII).

Referring again to FIG. 6L, operation 623 may further include operation 627 depicting selecting one or more targeted representations corresponding to one or more subtasks configured to be carried out by interface devices having the determined at least one of a status and a characteristic of the requestor interface device. For example, FIG. 2B shows determined status and/or characteristic targeted representation subtask selecting module 364 selecting one or more targeted representations (e.g., a car icon representing a subtask to be performed at a Nissan dealership) corresponding to one or more subtasks (e.g., “determine how many 370Zs are on the lot at Mike's Nissan Dealership”) configured to be carried out by interface devices having the determined at least one of a status and a characteristic of the requestor interface device (e.g., have a location that is at Mike's Nissan Dealership).

Referring now to FIG. 6M, operation 623 may include operation 629 depicting determining whether the requestor interface device has a particular sensor. For example, FIG. 2B shows requestor interface device particular sensor determining module 366 determining whether the requestor interface device (e.g., the HP Touchpad) has a particular sensor (e.g., a 3D camera).

Referring again to FIG. 6M, operation 623 may further include operation 631 depicting selecting one or more targeted representations corresponding to one or more subtasks configured to be carried out by interface devices having the particular sensor. For example, FIG. 2B shows interface device particular sensor targeted representation subtask selecting module 368 selecting one or more targeted representations (e.g., icons corresponding to taking 3D pictures of landmarks) corresponding to one or more subtasks (e.g., “take a picture of the St. Louis arch,” “take a picture of the Sears Tower,” “take a picture of the Hoover Dam”).

Referring again to FIG. 6M, operation 623 may include operation 633 depicting determining a location of the requestor interface device. For example, FIG. 2B shows requestor interface device location determining module 370 determining a location of the requestor interface device (e.g., determining a position of the iPhone 4).

Referring again to FIG. 6M, operation 623 may further include operation 635 depicting selecting one or more targeted representations configured to be carried out at the location of the requestor interface device. For example, FIG. 2B shows location-based targeted representation selecting module 372 selecting one or more targeted representations (e.g., graphics corresponding to “determine the humidity at Alki Beach,” “determine the pollen count at Alki Beach”) configured to be carried out at the location (e.g., Alki Beach) of the requestor interface device (e.g., the iPhone 4).

Referring now to FIG. 6N, operation 635 may include operation 637 depicting selecting one or more targeted representations configured to be carried out within a predetermined distance from the location of the requestor interface device. For example, FIG. 2B shows proximate-location-based targeted representation selecting module 374 selecting one or more targeted representations (e.g., graphics corresponding to “determine the UV index at Alki Beach”) configured to be carried out within a predetermined distance (e.g., 500 meters) from the location of the requestor interface device (e.g., an iPhone at Alki Beach).

Referring now to FIG. 6P, operation 625 may include operation 639 depicting receiving at least one of a status information of the requestor interface device and a characteristic information of the requestor interface device from the requestor interface device. For example, FIG. 2B shows requestor interface device status and/or characteristic receiving module 376 receiving at least one of a status information (e.g., “this interface device is located at Tully's Coffee Shop on 37^{th} St.”) of the requestor interface device (e.g., Motorola Droid 2) and a characteristic information (e.g., “this device has a camera”) of the requestor interface device (e.g., the Motorola Droid 2) from the requestor interface device (e.g., the Motorola Droid 2).

Referring again to FIG. 6P, operation 625 may include operation 641 depicting receiving at least one of a status information of the requestor interface device and a characteristic information of the requestor interface device from a provider of a communication network. For example, FIG. 2B shows communication network information receiving module 378 receiving at least one of a status information (e.g., “this interface device is in range of a wireless network”) of the requestor interface device (e.g., the Palm Pre) and a characteristic information (e.g., “this interface device has a wireless radio”) of the requestor device (e.g., the Palm Pre) from a provider of a communication network (e.g., AT&T).

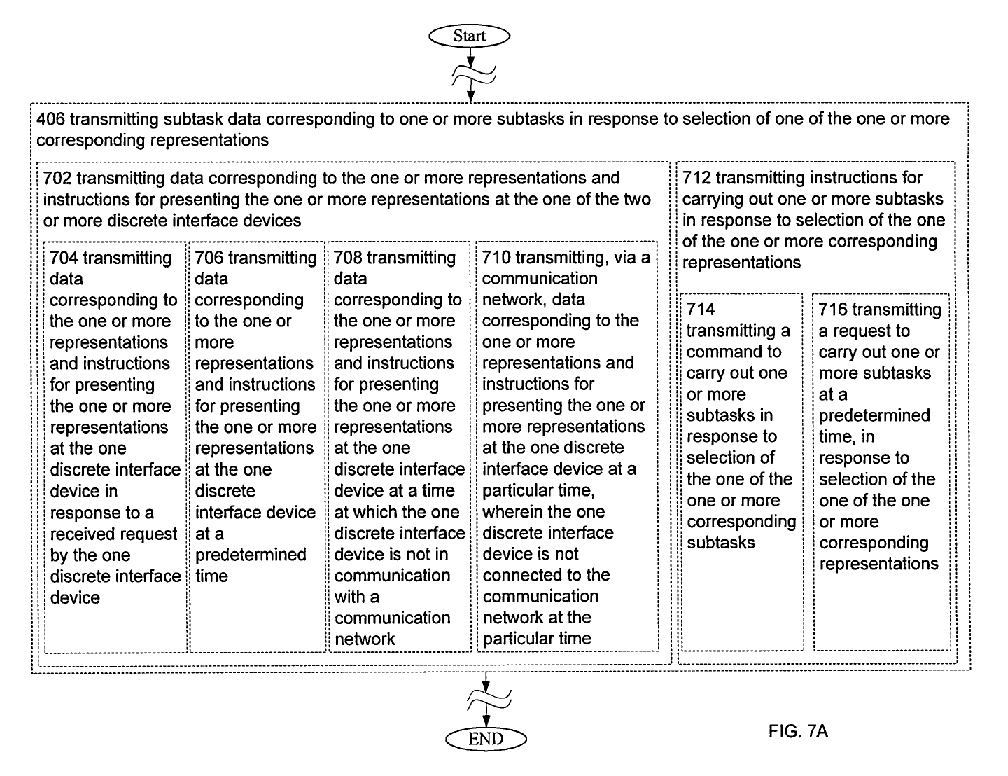

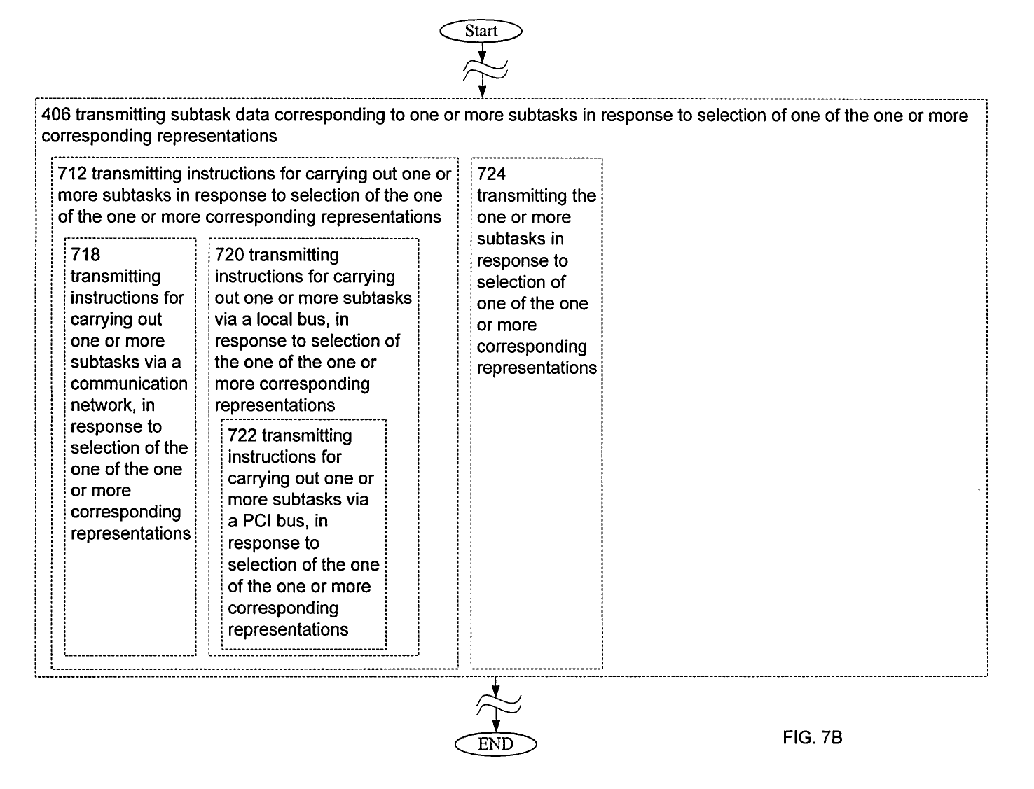

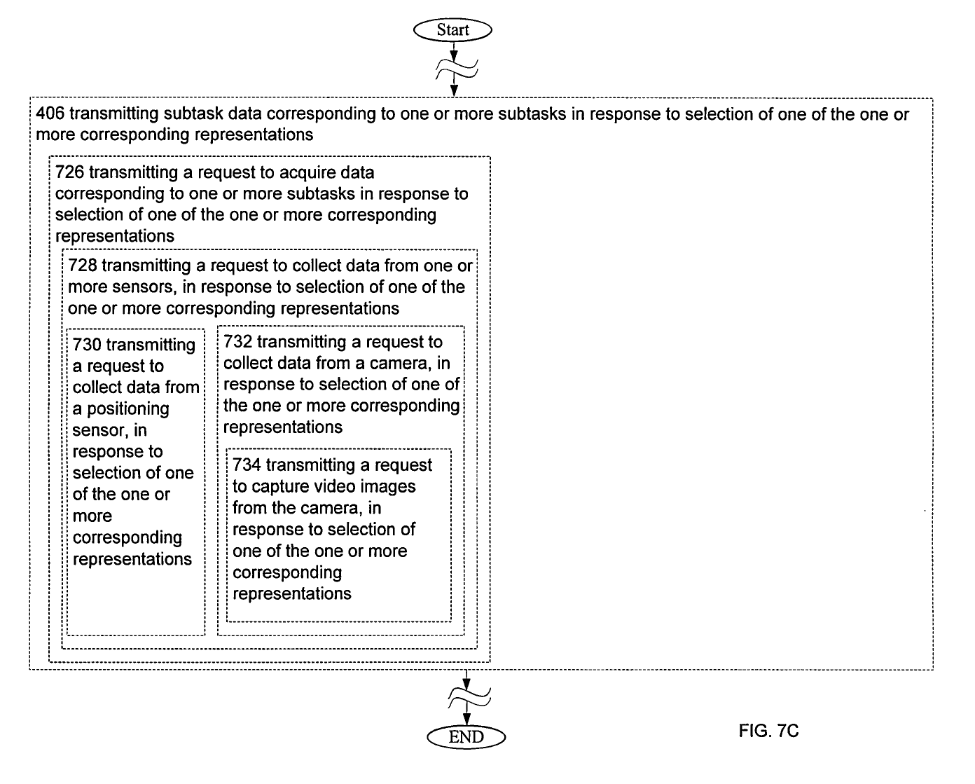

Referring now to FIG. 7A, operation 406 depicting transmitting subtask data corresponding to one or more subtasks in response to selection of one of the one or more corresponding representations may include operation 702 depicting transmitting data corresponding to the one or more representations and instructions for presenting the one or more representations at the one of the two or more discrete interface devices. For example, FIG. 2C depicts corresponding data and instructions selected subtask transmission module 226 transmitting data corresponding to the one or more representations (e.g., one or more Windows-style icons) and instructions for presenting the one or more representations (e.g., display coordinates and color palettes for displaying the one or more Windows-style icons) at the one of the two or more discrete interface devices (e.g., iPhone 4 and ASUS EeePc).

Referring again to FIG. 7A, operation 702 may include operation 704 depicting transmitting data corresponding to the one or more representations and instructions for presenting the one or more representations at the one discrete interface device in response to a received request by the one discrete interface device. For example, FIG. 2C shows responding data and instructions selected subtask transmission module 228 transmitting data corresponding to the one or more representations (e.g., one or more graphics) and instructions for presenting the one or more representations (e.g., processor interrupts and display execution routines) at the one discrete interface device in response to a received request (e.g., “please send representations and instructions for presenting the representations”) by the one discrete interface device (e.g., a Dell Latitude 8500).

Referring again to FIG. 7A, operation 702 may include operation 706 depicting transmitting data corresponding to the one or more representations and instructions for presenting the one or more representations at the one discrete interface device at a predetermined time. For example, FIG. 2C shows predetermined time representation and instruction transmitting module 230 transmitting data corresponding to the one or more representations (e.g., hyperlinks corresponding to tasks of “determine the wait to get a table at Boudreaux”) and instructions for presenting the one or more representations (e.g., hypertext markup) at the one discrete interface device (e.g., BlackBerry 8800) at a predetermined time (e.g., 8 pm, e.g., dinner time).

Referring again to FIG. 7A, operation 702 may include operation 708 depicting transmitting data corresponding to the one or more representations and instructions for presenting the one or more representations at the one discrete interface device at a time at which the one discrete interface device is not in communication with a communication network. For example, FIG. 2C shows no-communication corresponding data and instructions selected subtask transmission module 232 transmitting data corresponding to the one or more representations (e.g., hyperlinks corresponding to “What is the game day view from Section 21 of Notre Dame Stadium,” and “What is the game day view from Section 32 of Notre Dame Stadium”) and instructions for presenting the one or more representations (e.g., dynamic display instructions written in HTML5) at the one discrete interface device (e.g., Sony HandyCam) at a time which the one discrete interface device is not in communication with a communication network (e.g., is out of Wi-Fi range, or is out of 3G range).

Referring again to FIG. 7A, operation 702 may include operation 710 depicting transmitting, via a communication network, data corresponding to the one or more representations and instructions for presenting the one or more representations at the one discrete interface device at a particular time, wherein the one discrete interface device is not connected to the communication network at the particular time. For example, FIG. 7C shows delayed communication network data transmitting module 234 transmitting, via a communication network (e.g., Sprint's 4G WiMAX network), data corresponding to the one or more representations (e.g., icons corresponding to “determine a velocity inside the 1-90 tunnel” and instructions for presenting the one or more representations (e.g., commands for displaying icons on a touchscreen) at the one discrete interface device (e.g., the Droid Bionic) at a particular time (e.g., while the Droid Bionic is inside the 1-90 tunnel), wherein the one discrete interface device (e.g., the Droid Bionic) is not connected to the communication network at the particular time (e.g., the Droid Bionic may be unable to communicate with the Sprint 4G WiMAX network while the Droid Bionic is in the tunnel.

Referring again to FIG. 7A, operation 406 may include operation 712 depicting transmitting instructions for carrying out one or more subtasks in response to selection of the one of the one or more corresponding representations. For example, FIG. 7C shows responsive instruction transmitting module 236 transmitting instructions (e.g., “instruct user to lift interface device and point west,” “operate camera,” “transmit image”) for carrying out one or more subtasks (e.g., “take a picture of the Space Needle”) in response to selection of the one or more corresponding representations (e.g., touching the screen over the camera icon representing the “take a picture of the Space Needle” subtask).

Referring again to FIG. 7A, operation 712 may include operation 714 depicting transmitting a command to carry out one or more subtasks in response to selection of the one of the one or more corresponding subtasks. For example, FIG. 7C shows responsive command transmitting module 238 transmitting a command (e.g., “activate camera when light is detected”) to carry out one or more subtasks (e.g., “obtain a picture of Mt. Rushmore”) in response to selection of the one or more corresponding representations (e.g., clicking the hyperlink corresponding the “obtain a picture of Mt. Rushmore” subtask).

Referring again to FIG. 7A, operation 712 may include operation 716 depicting transmitting a request to carry out one or more subtasks at a predetermined time, in response to selection of the one of the one or more corresponding representations. For example, FIG. 7C shows predetermined time request transmitting module 221 transmitting a request (e.g., “measure the barometric pressure”) to carry out one or more subtasks (e.g., “determine whether the barometric pressure is rising or falling in the vicinity”) in response to selection of the one of the one or more corresponding representations (e.g., selecting the icon corresponding to the “measure the barometric pressure” subtask).

Referring now to FIG. 7B, operation 712 may include operation 718 depicting transmitting instructions for carrying out one or more subtasks via a communication network, in response to selection of the one of the one or more corresponding representations. For example, FIG. 2C shows communication network transmitting module 223 transmitting instructions (e.g., “activate heart monitor”) for carrying out one or more subtasks (e.g., “measure the heart rate of user”) via a communication network (e.g., AT&T EDGE network), in response to selection of the one of the one or more corresponding representations (e.g., in response to voice-selecting the representation for measuring heart rate).

Referring again to FIG. 7B, operation 712 may include operation 720 depicting transmitting instructions for carrying out one or more subtasks via a local bus, in response to selection of the one of the one or more corresponding representations. For example, FIG. 2C shows local bus instructions transmission module 225 transmitting instructions (e.g., “activate microphone for 5 seconds”) for carrying out one or more subtasks (e.g., “measure the decibel level at the Pearl Jam concert”) via a local bus (e.g., the memory bus of an ASUS Transformer), in response to selection of the one of the one or more corresponding representations (e.g., selection of the microphone icon corresponding to the “measure the decibel level at the Pearl Jam concert” subtask).

Referring again to FIG. 7B, operation 712 may include operation 722 depicting transmitting instructions for carrying out one or more subtasks via a PCI bus, in response to selection of the one of the one or more corresponding representations. For example, FIG. 2C shows PCI bus transmitting module 227 transmitting instructions (e.g., “activate web camera”) for carrying out one or more subtasks (e.g., “determine ambient light”) via a PCI bus (e.g., the PCI Bus of a Dell Latitude laptop), in response to selection of the one of the one or more corresponding representations (e.g., in response to a user pressing a hotkey for selecting the one of the one or more corresponding representations).

Referring again to FIG. 7B, operation 406 may include operation 724 depicting transmitting the one or more subtasks in response to selection of one of the one or more corresponding representations. For example, FIG. 2C shows subtask transmitting module 229 transmitting the one or more subtasks (e.g., “determine an ambient temperature”) in response to selection of one of the one or more corresponding representations (e.g., selecting an icon corresponding to determining an ambient temperature. In some embodiments, only the subtask is transmitted to the interface device, and the processor of the interface device determines how to carry out the subtask.

Referring again to FIG. 7B, operation 406 may include operation 726 depicting transmitting a request to acquire data corresponding to one or more subtasks in response to selection of one of the one or more corresponding representations. For example, FIG. 2C shows data acquisition request transmitting module 231 transmitting a request to acquire data (e.g., “use the seismometer to detect seismic activity”) corresponding to one or more subtasks (e.g., “measure the seismic activity in an area”) in response to selection of one of the one or more corresponding representations (e.g., selecting an icon corresponding to collecting seismic data).

Referring now to FIG. 7C, operation 726 may include operation 728 depicting transmitting a request to collect data from one or more sensors, in response to selection of one of the one or more corresponding representations. For example, FIG. 2C shows sensor data acquisition request transmitting module 233 transmitting a request to acquire data (e.g., “use the air quality sensor to measure the level of mold spores”) corresponding to one or more subtasks (e.g., “measure the air quality in an area”) in response to selection of one of the one or more corresponding representations (e.g., selecting an icon corresponding to collecting air quality data).

Referring again to FIG. 7C, operation 728 may include operation 730 depicting transmitting a request to collect data from a positioning sensor, in response to selection of one of the one or more corresponding representations. For example, FIG. 2C shows positioning sensor data acquisition request transmitting module 235 transmitting a request to collect data (e.g., “determine which position has the most sunlight”) from a positioning sensor (e.g., a GPS sensor), in response to selection of the one or more corresponding representations (e.g., using a mouse to click on a sun icon corresponding to the “determine which seat in a restaurant has the most sunlight” subtask).

Referring again to FIG. 7C, operation 728 may include operation 732 depicting transmitting a request to collect data from a camera, in response to selection of one of the one or more corresponding representations. For example, FIG. 2C shows camera data acquisition request transmitting module 237 transmitting a request to collect data (e.g., “capture the view from the Tira Misu Restaurant balcony”) from a camera (e.g., the camera on the iPhone 4), in response to selection of one of the one or more corresponding representations (e.g., selecting the camera icon in the “application store” application running on the iPhone 4”).

Referring again to FIG. 7C, operation 732 may include operation 734 depicting transmitting a request to capture video images from the camera, in response to selection of one of the one or more corresponding representations. For example, FIG. 2C shows camera video data acquisition request transmitting module 239 transmitting a request to capture video images (e.g., “take a video of the sunset by Bob's Bed and Breakfast in Mukilteo”) from the camera, in response to selection of one of the one or more corresponding representations. (e.g., selecting the video camera icon in the Android Marketplace, for example).

The foregoing detailed description has set forth various embodiments of the devices and/or processes via the use of block diagrams, flowcharts, and/or examples. Insofar as such block diagrams, flowcharts, and/or examples contain one or more functions and/or operations, it will be understood by those within the art that each function and/or operation within such block diagrams, flowcharts, or examples can be implemented, individually and/or collectively, by a wide range of hardware, software, firmware, or virtually any combination thereof. In one embodiment, several portions of the subject matter described herein may be implemented via Application Specific Integrated Circuitry (ASICs), Field Programmable Gate Arrays (FPGAs), digital signal processors (DSPs), or other integrated formats. However, those skilled in the art will recognize that some aspects of the embodiments disclosed herein, in whole or in part, can be equivalently implemented in integrated circuitry, as one or more computer programs running on one or more computers (e.g., as one or more programs running on one or more computer systems), as one or more programs running on one or more processors (e.g., as one or more programs running on one or more microprocessors), as firmware, or as virtually any combination thereof, and that designing the circuitry and/or writing the code for the software and or firmware would be well within the skill of one of skill in the art in light of this disclosure. In addition, those skilled in the art will appreciate that the mechanisms of the subject matter described herein are capable of being distributed as a program product in a variety of forms, and that an illustrative embodiment of the subject matter described herein applies regardless of the particular type of signal bearing medium used to actually carry out the distribution. Examples of a signal bearing medium include, but are not limited to, the following: a recordable type medium such as a floppy disk, a hard disk drive, a Compact Disc (CD), a Digital Video Disk (DVD), a digital tape, a computer memory, etc.; and a transmission type medium such as a digital and/or an analog communication medium (e.g., a fiber optic cable, a waveguide, a wired communications link, a wireless communication link, etc.).

Alternatively or additionally, implementations may include executing a special-purpose instruction sequence or invoking circuitry for enabling, triggering, coordinating, requesting, or otherwise causing one or more occurrences of virtually any functional operations described herein. In some variants, operational or other logical descriptions herein may be expressed as source code and compiled or otherwise invoked as an executable instruction sequence. In some contexts, for example, implementations may be provided, in whole or in part, by source code, such as C++, or other code sequences. In other implementations, source or other code implementation, using commercially available and/or techniques in the art, may be compiled//implemented/translated/converted into a high-level descriptor language (e.g., initially implementing described technologies in C or C++ programming language and thereafter converting the programming language implementation into a logic-synthesizable language implementation, a hardware description language implementation, a hardware design simulation implementation, and/or other such similar mode(s) of expression). For example, some or all of a logical expression (e.g., computer programming language implementation) may be manifested as a Verilog-type hardware description (e.g., via Hardware Description Language (HDL) and/or Very High Speed Integrated Circuit Hardware Descriptor Language (VHDL)) or other circuitry model which may then be used to create a physical implementation having hardware (e.g., an Application Specific Integrated Circuit). Those skilled in the art will recognize how to obtain, configure, and optimize suitable transmission or computational elements, material supplies, actuators, or other structures in light of these teachings.

In a general sense, those skilled in the art will recognize that the various aspects described herein which can be implemented, individually and/or collectively, by a wide range of hardware, software, firmware, or any combination thereof can be viewed as being composed of various types of “electrical circuitry.” Consequently, as used herein “electrical circuitry” includes, but is not limited to, electrical circuitry having at least one discrete electrical circuit, electrical circuitry having at least one integrated circuit, electrical circuitry having at least one application specific integrated circuit, electrical circuitry forming a general purpose computing device configured by a computer program (e.g., a general purpose computer configured by a computer program which at least partially carries out processes and/or devices described herein, or a microprocessor configured by a computer program which at least partially carries out processes and/or devices described herein), electrical circuitry forming a memory device (e.g., forms of random access memory), and/or electrical circuitry forming a communications device (e.g., a modem, communications switch, or optical-electrical equipment). Those having skill in the art will recognize that the subject matter described herein may be implemented in an analog or digital fashion or some combination thereof.

Those having skill in the art will recognize that it is common within the art to describe devices and/or processes in the fashion set forth herein, and thereafter use engineering practices to integrate such described devices and/or processes into data processing systems. That is, at least a portion of the devices and/or processes described herein can be integrated into a data processing system via a reasonable amount of experimentation. Those having skill in the art will recognize that a typical data processing system generally includes one or more of a system unit housing, a video display device, a memory such as volatile and non-volatile memory, processors such as microprocessors and digital signal processors, computational entities such as operating systems, drivers, graphical user interfaces, and applications programs, one or more interaction devices, such as a touch pad or screen, and/or control systems including feedback loops and control motors (e.g., feedback for sensing position and/or velocity; control motors for moving and/or adjusting components and/or quantities). A typical data processing system may be implemented utilizing any suitable commercially available components, such as those typically found in data computing/communication and/or network computing/communication systems.

Those skilled in the art will recognize that it is common within the art to implement devices and/or processes and/or systems, and thereafter use engineering and/or other practices to integrate such implemented devices and/or processes and/or systems into more comprehensive devices and/or processes and/or systems. That is, at least a portion of the devices and/or processes and/or systems described herein can be integrated into other devices and/or processes and/or systems via a reasonable amount of experimentation. Those having skill in the art will recognize that examples of such other devices and/or processes and/or systems might include—as appropriate to context and application—all or part of devices and/or processes and/or systems of (a) an air conveyance (e.g., an airplane, rocket, helicopter, etc.), (b) a ground conveyance (e.g., a car, truck, locomotive, tank, armored personnel carrier, etc.), (c) a building (e.g., a home, warehouse, office, etc.), (d) an appliance (e.g., a refrigerator, a washing machine, a dryer, etc.), (e) a communications system (e.g., a networked system, a telephone system, a Voice over IP system, etc.), (f) a business entity (e.g., an Internet Service Provider (ISP) entity such as Comcast Cable, Qwest, Southwestern Bell, etc.), or (g) a wired/wireless services entity (e.g., Sprint, Cingular, Nextel, etc.), etc.

In certain cases, use of a system or method may occur in a territory even if components are located outside the territory. For example, in a distributed computing context, use of a distributed computing system may occur in a territory even though parts of the system may be located outside of the territory (e.g., relay, server, processor, signal-bearing medium, transmitting computer, receiving computer, etc. located outside the territory)

The herein described subject matter sometimes illustrates different components contained within, or connected with, different other components. It is to be understood that such depicted architectures are merely exemplary, and that in fact many other architectures can be implemented which achieve the same functionality. In a conceptual sense, any arrangement of components to achieve the same functionality is effectively “associated” such that the desired functionality is achieved. Hence, any two components herein combined to achieve a particular functionality can be seen as “associated with” each other such that the desired functionality is achieved, irrespective of architectures or intermediate components. Likewise, any two components so associated can also be viewed as being “operably connected”, or “operably coupled”, to each other to achieve the desired functionality, and any two components capable of being so associated can also be viewed as being “capable of being operably coupled”, to each other to achieve the desired functionality. Specific examples of operably coupled include but are not limited to physically mateable and/or physically interacting components and/or wirelessly interactable and/or wirelessly interacting components and/or logically interacting and/or logically interactable components.

Those skilled in the art will recognize that at least a portion of the devices and/or processes described herein can be integrated into a data processing system. Those having skill in the art will recognize that a data processing system generally includes one or more of a system unit housing, a video display device, memory such as volatile or non-volatile memory, processors such as microprocessors or digital signal processors, computational entities such as operating systems, drivers, graphical user interfaces, and applications programs, one or more interaction devices (e.g., a touch pad, a touch screen, an antenna, etc.), and/or control systems including feedback loops and control motors (e.g., feedback for sensing position and/or velocity; control motors for moving and/or adjusting components and/or quantities). A data processing system may be implemented utilizing suitable commercially available components, such as those typically found in data computing/communication and/or network computing/communication systems

While particular aspects of the present subject matter described herein have been shown and described, it will be apparent to those skilled in the art that, based upon the teachings herein, changes and modifications may be made without departing from the subject matter described herein and its broader aspects and, therefore, the appended claims are to encompass within their scope all such changes and modifications as are within the true spirit and scope of the subject matter described herein. Furthermore, it is to be understood that the invention is defined by the appended claims.

It will be understood by those within the art that, in general, terms used herein, and especially in the appended claims (e.g., bodies of the appended claims) are generally intended as “open” terms (e.g., the term “including” should be interpreted as “including but not limited to,” the term “having” should be interpreted as “having at least,” the term “includes” should be interpreted as “includes but is not limited to,” etc.). It will be further understood by those within the art that if a specific number of an introduced claim recitation is intended, such an intent will be explicitly recited in the claim, and in the absence of such recitation no such intent is present. For example, as an aid to understanding, the following appended claims may contain usage of the introductory phrases “at least one” and “one or more” to introduce claim recitations. However, the use of such phrases should not be construed to imply that the introduction of a claim recitation by the indefinite articles “a” or “an” limits any particular claim containing such introduced claim recitation to inventions containing only one such recitation, even when the same claim includes the introductory phrases “one or more” or “at least one” and indefinite articles such as “a” or “an” (e.g., “a” and/or “an” should typically be interpreted to mean “at least one” or “one or more”); the same holds true for the use of definite articles used to introduce claim recitations.

In addition, even if a specific number of an introduced claim recitation is explicitly recited, those skilled in the art will recognize that such recitation should typically be interpreted to mean at least the recited number (e.g., the bare recitation of “two recitations,” without other modifiers, typically means at least two recitations, or two or more recitations). Furthermore, in those instances where a convention analogous to “at least one of A, B, and C, etc.” is used, in general such a construction is intended in the sense one having skill in the art would understand the convention (e.g., “a system having at least one of A, B, and C” would include but not be limited to systems that have A alone, B alone, C alone, A and B together, A and C together, B and C together, and/or A, B, and C together, etc.).

In those instances where a convention analogous to “at least one of A, B, or C, etc.” is used, in general such a construction is intended in the sense one having skill in the art would understand the convention (e.g., “a system having at least one of A, B, or C” would include but not be limited to systems that have A alone, B alone, C alone, A and B together, A and C together, B and C together, and/or A, B, and C together, etc.). It will be further understood by those within the art that virtually any disjunctive word and/or phrase presenting two or more alternative terms, whether in the description, claims, or drawings, should be understood to contemplate the possibilities of including one of the terms, either of the terms, or both terms. For example, the phrase “A or B” will be understood to include the possibilities of “A” or “B” or “A and B.”

With respect to the appended claims, those skilled in the art will appreciate that recited operations therein may generally be performed in any order. Also, although various operational flows are presented in a sequence(s), it should be understood that the various operations may be performed in other orders than those which are illustrated, or may be performed concurrently. Examples of such alternate orderings may include overlapping, interleaved, interrupted, reordered, incremental, preparatory, supplemental, simultaneous, reverse, or other variant orderings, unless context dictates otherwise. Furthermore, terms like “responsive to,” “related to,” or other past-tense adjectives are generally not intended to exclude such variants, unless context dictates otherwise.

Those skilled in the art will appreciate that the foregoing specific exemplary processes and/or devices and/or technologies are representative of more general processes and/or devices and/or technologies taught elsewhere herein, such as in the claims filed herewith and/or elsewhere in the present application.

1-172. (canceled)

173. A system, comprising:
an ignorant interface device subtask acquiring module configured to acquire one or more subtasks that are configured to be carried out by two or more discrete interface devices and which correspond to portions of one or more tasks, wherein at least one of the one or more tasks and an requestor of the one or more tasks are undisclosed to the two or more discrete interface devices;
a corresponding subtask representation presentation module configured to present representations corresponding to the one or more subtasks; and
a selected subtask data transmission module configured to transmit a subtask of the one or more subtasks corresponding to a selected representation.

174. The system of claim 173, wherein said ignorant interface device subtask acquiring module configured to acquire one or more subtasks that are configured to be carried out by two or more discrete interface devices and which correspond to portions of one or more tasks, wherein at least one of the one or more tasks and an requestor of the one or more tasks are undisclosed to the two or more discrete interface devices comprises:
an absent knowledge interface device subtask acquiring module configured to acquire one or more subtasks that are configured to be carried out by two or more discrete interface devices and which correspond to portions of one or more tasks, wherein the one or more subtasks are configured to be carried out in an absence of knowledge at the two or more discrete interface devices of at least one of the one or more tasks and a requestor of the one or more tasks.

175. The system of claim 173, wherein said ignorant interface device subtask acquiring module configured to acquire one or more subtasks that are configured to be carried out by two or more discrete interface devices and which correspond to portions of one or more tasks, wherein at least one of the one or more tasks and an requestor of the one or more tasks are undisclosed to the two or more discrete interface devices comprises:
a discrete source interface device subtask acquiring module configured to acquire one or more subtasks that are configured to be carried out by two or more discrete interface devices and which correspond to portions of one or more tasks acquired from a source that is discrete from the two or more discrete interface devices.

176. The system of claim 173, wherein said ignorant interface device subtask acquiring module configured to acquire one or more subtasks that are configured to be carried out by two or more discrete interface devices and which correspond to portions of one or more tasks, wherein at least one of the one or more tasks and an requestor of the one or more tasks are undisclosed to the two or more discrete interface devices comprises:
a one-or-more subtask retrieving module configured to retrieve one or more subtasks that correspond to portions of one or more tasks.

177. The system of claim 176, wherein said one-or-more subtask retrieving module configured to retrieve one or more subtasks that correspond to portions of one or more tasks comprises:
a one-or-more-subtask database retrieving module configured to retrieve the one or more subtasks from a database.

178-179. (canceled)

180. The system of claim 173, wherein said ignorant interface device subtask acquiring module configured to acquire one or more subtasks that are configured to be carried out by two or more discrete interface devices and which correspond to portions of one or more tasks, wherein at least one of the one or more tasks and an requestor of the one or more tasks are undisclosed to the two or more discrete interface devices comprises:
a one-or-more subtask creation module configured to create the one or more subtasks.

181. (canceled)

182. The system of claim 173, wherein said ignorant interface device subtask acquiring module configured to acquire one or more subtasks that are configured to be carried out by two or more discrete interface devices and which correspond to portions of one or more tasks, wherein at least one of the one or more tasks and an requestor of the one or more tasks are undisclosed to the two or more discrete interface devices comprises:
a one-or-more subtask generating module configured to generate one or more subtasks.

183. The system of claim 173, wherein said ignorant interface device subtask acquiring module configured to acquire one or more subtasks that are configured to be carried out by two or more discrete interface devices and which correspond to portions of one or more tasks, wherein at least one of the one or more tasks and an requestor of the one or more tasks are undisclosed to the two or more discrete interface devices comprises:
a one-or-more subtask receiving module configured to receive the one or more subtasks from a source.

184. The system of claim 173, wherein said ignorant interface device subtask acquiring module configured to acquire one or more subtasks that are configured to be carried out by two or more discrete interface devices and which correspond to portions of one or more tasks, wherein at least one of the one or more tasks and an requestor of the one or more tasks are undisclosed to the two or more discrete interface devices comprises:
a remote task transmitting module configured to transmit the one or more tasks to a location; and
a remote subtask receiving module configured to receive the one or more tasks from a remote location.

185. (canceled)

186. The system of claim 173, wherein said corresponding subtask representation presentation module configured to present representations corresponding to the one or more subtasks comprises:
a corresponding subtask symbol displaying module configured to display one or more symbols that correspond to the one or more subtasks.

187. The system of claim 186, wherein said corresponding subtask symbol displaying module configured to display one or more symbols that correspond to the one or more subtasks comprises:
a corresponding subtask graphic and text string symbol displaying module configured to display one or more graphics and one or more text strings corresponding to the one or more graphics, wherein the one or more graphics and the one or more text strings correspond to the one or more subtasks.

188. The system of claim 186, wherein said corresponding subtask symbol displaying module configured to display one or more symbols that correspond to the one or more subtasks comprises:
a corresponding graphic symbol displaying module configured to display one or more graphic symbols corresponding to the one or more subtasks.

189. The system of claim 186, wherein said corresponding subtask symbol displaying module configured to display one or more symbols that correspond to the one or more subtasks comprises:
a corresponding icon symbol displaying module configured to display one or more icon symbols corresponding to the one or more subtasks.

190-191. (canceled)

192. The system of claim 186, wherein said corresponding subtask symbol displaying module configured to display one or more symbols that correspond to the one or more subtasks comprises:
a corresponding hyperlink symbol displaying module configured to display one or more hyperlink symbols corresponding to the one or more subtasks.

193. The system of claim 173, wherein said corresponding subtask representation presentation module configured to present representations corresponding to the one or more subtasks comprises:
a discrete interface device presentation invoking module configured to cause a discrete interface device to invoke a presentation of the one or more representations.

194. The system of claim 193, wherein said corresponding subtask representation presentation module configured to present representations corresponding to the one or more subtasks further comprises:
a further discrete interface device presentation invoking module configured to cause a further discrete interface device to invoke a presentation of the one or more representations.

195. The system of claim 193, wherein said discrete interface device presentation invoking module configured to cause a discrete interface device to invoke a presentation of the one or more representations comprises:
an each-device discrete interface device presentation invoking module configured to cause each discrete interface device of the two or more discrete interface devices to invoke a presentation of the one or more representations.

196. The system of claim 193, wherein said discrete interface device presentation invoking module configured to cause a discrete interface device to invoke a presentation of the one or more representations comprises:
a discrete interface device presentation instructing module configured to instruct a discrete interface device to invoke a presentation of the one or more representations.

197. (canceled)

198. The system of claim 193, wherein said discrete interface device presentation invoking module configured to cause a discrete interface device to invoke a presentation of the one or more representations comprises:
a discrete interface device presentation request transmitting module configured to transmit, to a discrete interface device, a request to present of the one or more representations.

199. The system of claim 198, wherein said discrete interface device presentation request transmitting module configured to transmit, to a discrete interface device, a request to present of the one or more representations comprises:
a discrete interface device display request transmitting module configured to transmit, to a discrete interface device, a request to display the one or more representations.

200-201. (canceled)

202. The system of claim 193, wherein said discrete interface device presentation invoking module configured to cause a discrete interface device to invoke a presentation of the one or more representations comprises:
a discrete interface device presentation authorization module configured to authorize a discrete interface device to present the one or more representations.

203. (canceled)

204. The system of claim 186, wherein said corresponding subtask symbol displaying module configured to display one or more symbols that correspond to the one or more subtasks comprises:
a representation presentation request receiving module; and
a corresponding subtask representation presentation module.

205-220. (canceled)

221. The system of claim 204, wherein said corresponding subtask representation presentation module comprises:
a targeted representation corresponding subtask selecting module; and
a targeted corresponding subtask representation presentation module.

222. The system of claim 221, wherein said targeted representation corresponding subtask selecting module comprises:
a particular status and/or characteristic interface device targeted representation selecting module.

223. The system of claim 222, wherein said particular status and/or characteristic interface device targeted representation selecting module comprises:
a particular status interface device targeted representation selecting module configured to select one or more targeted representations.

224. The system of claim 222, wherein said particular status and/or characteristic interface device targeted representation selecting module comprises:
a particular characteristic interface device targeted representation selecting module configured to select one or more targeted representations.

225. The system of claim 222, wherein said particular status and/or characteristic interface device targeted representation selecting module comprises:
an environment-dependent particular interface device targeted representation selecting module configured to select targeted representations corresponding to one or more subtasks configured to be carried out by interface devices having at least one particular property that is dependent upon a discrete interface device environment.

226. The system of claim 225, wherein said environment-dependent particular interface device targeted representation selecting module configured to select targeted representations corresponding to one or more subtasks configured to be carried out by interface devices having at least one particular property that is dependent upon a discrete interface device environment comprises:
a specific status interface device targeted representation selecting module configured to select targeted representations corresponding to one or more subtasks configured to be carried out by interface devices having one or more of a specific position, proximity to a predetermined point, acceleration, velocity, and an ambient condition surrounding the interface device.

227. The system of claim 222, wherein said particular status and/or characteristic interface device targeted representation selecting module comprises:
an environment-independent particular interface device targeted representation selecting module configured to select targeted representations corresponding to one or more subtasks configured to be carried out by interface devices having at least one particular property that is independent from a discrete interface device environment.

228. The system of claim 227, wherein said environment-independent particular interface device targeted representation selecting module configured to select targeted representations corresponding to one or more subtasks configured to be carried out by interface devices having at least one particular property that is independent from a discrete interface device environment comprises:
a specific characteristic interface device targeted representation selecting module configured to select targeted representations corresponding to one or more subtasks configured to be carried out by interface devices having one or more of a Global Positioning System (GPS) sensor, a still camera, a video camera, an altimeter, an air quality sensor, a barometer, an accelerometer, a charge-coupled device, a radio, a thermometer, a pedometer, a heart monitor, a moisture sensor, a humidity sensor, a microphone, a seismometer, and a magnetic field sensor.

229. The system of claim 222, wherein said representation presentation request receiving module comprises:
a requestor interface device representation presentation request receiving module.

230. The system of claim 229, wherein said targeted representation corresponding subtask selecting module comprises:
a requestor interface device targeted representation corresponding subtask selecting module.

231. The system of claim 230, wherein said requestor interface device targeted representation corresponding subtask selecting module comprises:
a requestor interface device status and/or characteristic determining module configured to determine one of a status and a characteristic of a requesting interface device; and
a determined status and/or characteristic targeted representation subtask selecting module configured to select one or more subtasks determined to be capable of being carried out by the requestor interface device.

232. (canceled)

233. The system of claim 231, wherein said requestor interface device status and/or characteristic determining module configured to determine one of a status and a characteristic of a requesting interface device comprises:
a requestor interface device location determining module; and
a location-based targeted representation selecting module configured to select subtasks capable of being carried out at the location of the requestor interface device.

234. The system of claim 231, wherein said requestor interface device status and/or characteristic determining module configured to determine one of a status and a characteristic of a requesting interface device comprises:
a requestor interface device proximate location determining module; and
a proximate-location-based targeted representation selecting module configured to select subtasks capable of being carried out within a predetermined distance from the location of the requestor interface device.

235. The system of claim 231, wherein said requestor interface device status and/or characteristic determining module configured to determine one of a status and a characteristic of a requesting interface device comprises:
a requestor interface device status and/or characteristic receiving module configured to receive a requestor interface device status and/or characteristic information from the requestor interface device.

236. The system of claim 231, wherein said requestor interface device status and/or characteristic determining module configured to determine one of a status and a characteristic of a requesting interface device comprises:
a communication network provider interface device status and/or characteristic receiving module configured to receive a requestor interface device status and/or characteristic information from a provider of a communication network.

237. The system of claim 173, wherein said selected subtask data transmission module configured to transmit a subtask of the one or more subtasks corresponding to a selected representation comprises:
a corresponding data and instructions selected subtask transmission module configured to transmit data corresponding to the one or more representations and instructions for presenting the one or more representations.

238. The system of claim 237, wherein said corresponding data and instructions selected subtask transmission module configured to transmit data corresponding to the one or more representations and instructions for presenting the one or more representations comprises:
a responding data and instructions selected subtask transmission module configured to transmit data corresponding to the one or more representations and instructions for presenting the one or more representations in response to a received request.

239-240. (canceled)

241. The system of claim 173, wherein said selected subtask data transmission module configured to transmit a subtask of the one or more subtasks corresponding to a selected representation comprises:
a corresponding subtask execution instructions transmission module configured to transmit instructions for carrying out the one or more subtasks in response to a selection of the selected representation.

242. (canceled)

243. The system of claim 173, wherein said selected subtask data transmission module configured to transmit a subtask of the one or more subtasks corresponding to a selected representation comprises:
a data acquisition request transmitting module configured to transmit a request to acquire data corresponding to the one or more subtasks.

244. The system of claim 243, wherein said data acquisition request transmitting module configured to transmit a request to acquire data corresponding to the one or more subtasks comprises:
a sensor data acquisition request transmitting module configured to transmit a request to use a particular sensor of one of the two or more discrete interface devices to acquire data corresponding to the one or more subtasks.

245. (canceled)
